(19) United States
(12) Patent Application Publication
(10) Pub. No.: US 2025/0266693 A1
(43) Pub. Date: Aug. 21, 2025

(54) CIRCUIT ARRANGEMENT FOR CONTROLLING OUTPUT VOLTAGE

(71) Applicant: SEM AB, ÅMÅL (SE)

(72) Inventors: Bo BIJLENGA, ÅMÅL (SE); Jakob ÄNGEBY, Vålberg (SE)

(21) Appl. No.: 18/558,986

(22) PCT Filed: May 11, 2021
(86) PCT No.: PCT/EP2021/062523

§ 371 Date: Nov. 3, 2023

(51) Int. Cl. H02J 7/00

(52) U.S. Cl. CPC H02J 7/0024; H02J 7/0016; H02J 7/0047

(57) ABSTRACT

A circuit arrangement (10) for controlling an output voltage of the circuit arrangement (10). The circuit arrangement (10) comprises battery cells (121) forming a plurality of series-connectable cell modules (120, 120′). The cell modules (120, 120′) comprise: a first group of cell modules (150) comprising a first number of cell modules (150), Each cell module (120, 120′) of the first group has a first nominal cell module voltage in a range of 30-200 V, and at least one second group of cell modules (150′) comprising a second number of cell modules (150′). Each cell module (120, 120′) of said at least one second group has a second nominal cell module voltage that is less than the first nominal cell module voltage. The circuit arrangement (10) comprises a control unit (20) configured to: measure the output voltage of the circuit arrangement (10), and in order to control the measured output voltage towards the voltage target, control at least one respective electronic module (100, 100′) to adjust a respective contributing number of cell modules (120, 120′) of at least one of the first and second groups. Each cell module (120, 120′) of the respective contributing number of cell modules (120, 120′) is contributing, positively or negatively, to the output voltage of the circuit arrangement (10).

### TECHNICAL FIELD

Embodiments herein relate to circuit arrangements with controllable voltage and/or current, such as battery systems, battery packs, battery assemblies or the like. In particular, a circuit arrangement for controlling an output voltage of the circuit arrangement towards a voltage target for exchange of electric power with an electric power unit is disclosed.

### BACKGROUND

Circuit arrangements for battery packs, rechargeable batteries and the like are used in many different applications ranging from powering electric motors of vehicles, ships, aircrafts, electronic devices of various kinds, providing energy storage for electric grids, electric power systems, in stations for storing solar or wind energy, in charging stations for electric vehicles and more.

A known battery pack typically comprises a plurality of cell modules, or sometimes referred to as a string of cell modules, battery modules or the like. The plurality of cell modules is typically connected in series, whereby their respective voltages add up to an output voltage of the battery pack. Each battery module comprises one or more battery cells.

In many applications, it would be a great advantage if it would be possible to control the output voltage of a battery pack. Also, it is an advantage if this voltage control can be combined with utilizing all the individual battery cells in the battery during the lifetime of the battery in an optimal way, without making the battery cell with lowest remaining capacity to limit the capacity of the battery as a whole. This is normally referred to as active cell balancing. Many solutions of how to do this exists in related literature. Most of the existing solutions use semiconductor switches in different configurations, which are controlled by a control unit, to achieve the active cell balancing.

In for example vehicle applications, voltage controllability of batteries opens up many new possibilities for how batteries can be utilised. The total electric drive chain can be optimised and both cost and losses in inverters, cables and electric motors can be saved due to a tighter voltage specification of the battery. This is due to the fact that the output voltage of most batteries is reduced when the battery is discharged and the voltage is also a function of current, temperature and how old the battery is. When voltage is reduced, the current needs to be increased for the battery to deliver a certain power. As a consequence, the battery, as well as other electronic equipment, need to be designed for higher currents than would be necessary if the voltage could be maintained at, or at least close to, a configurable level. Disadvantageously, additional losses are created due to the higher current.

Batteries with full control of the output voltage can also be parallel connected more effectively, since the voltage control can be used to control current sharing between the batteries. Different type of batteries can be combined with each other, as well as new and old types of batteries. The voltage used at charging, e.g. battery packs in a vehicle, can be increased and kept as high as possible during the charging time, which reduces losses and the time to charge the battery. The vehicle can also be charged with a charging station rated for lower voltage than the nominal output voltage of the battery, in case the charging station cannot deliver nominal output voltage. One vehicle can be used to charge another vehicle, acting as a charging station, etc.

### SUMMARY

An object may be to eliminate, or at least reduce, one or more the abovementioned disadvantages and/or problems.

According to one aspect, the objective is achieved by a circuit arrangement, such as a battery pack, a battery arrangement or the like, for controlling an output voltage of the circuit arrangement towards a voltage target for exchange of electric power with an electric power unit. The circuit arrangement comprises battery cells forming a plurality of series-connectable cell modules, and a pair of terminals for connection of the electric power unit. The output voltage between the pair of terminals is controllable. Each series-connectable cell module is connected to a respective electronic module, controllable to include said each cell module for contribution to the output voltage or to bypass said each cell module for exclusion from contribution to the output voltage.

The cell modules comprise:
a first group of cell modules comprising a first number of cell modules. Each cell module of the first group has a first nominal cell module voltage in a range of 30-200 V, and
at least one second group of cell modules comprising a second number of cell modules. Each cell module of said at least one second group has a second nominal cell module voltage that is less than the first nominal cell module voltage.

Furthermore, the circuit arrangement comprises a control unit configured to: measure the output voltage of the circuit arrangement, and in order to control the measured output voltage towards the voltage target, control at least one respective electronic module to adjust a respective contributing number of cell modules of at least one of the first and second groups. Each cell module of the respective contributing number of cell modules is contributing, positively or negatively, to the output voltage of the circuit arrangement.

Thanks to that the first nominal cell module voltage, being in the range of 30-200 V, a relatively low number of cell modules from the first group is required to reach, or at least be close to, the voltage target. The voltage target is here assumed to be in the range of 400V to 1200V, but even higher voltage may be used depending on application. This means that it is possible to make a coarse voltage control of the output voltage, using a small number of switching components, which are included in the respective electronic module connected to each cell module. The coarse voltage control is thus provided by controlling the first group's cell modules to either contribute or not contribute to the output voltage. This reduces the total cost of the electronic modules. As the current needs to pass a number of switching components, it is preferred to reduce the number of switching components that the current has to pass to reduce conduction losses. According to the embodiments herein, the switching components may typically operate at a very low switching frequency, such as in the frequency range of 0.01 Hz-10 Hz. Therefore, also switching losses will be small. By means of the second group of cell modules, where the cell modules in the second group have lower nominal cell module voltage than the cell modules in the first group, finer control of the output voltage will be possible. This can continue with further groups, with cell modules with even less nominal cell module voltage, until a desired resolution of the output voltage is achieved. This way it is possible to combine a very good voltage controllability and voltage resolution, with low cost and low losses. One reason for controlling the output voltage of the circuit arrangement, such as a battery or an energy storage system including batteries or the like, is that if the voltage always can be kept close to maximum possible voltage, and the hereby current flowing in the circuit arrangement may be reduced, such as minimized. As currents in the system normally causes losses, the energy losses in the circuit arrangement may be reduced, or even minimized.

### BRIEF DESCRIPTION OF THE DRAWINGS

The various aspects of embodiments disclosed herein, including particular features and advantages thereof, will be readily understood from the following detailed description and the accompanying drawings, which are briefly described in the following.

FIG. 1 is a schematic circuit diagram of an exemplifying circuit arrangement according to the embodiments herein.

FIG. 2 is an illustration of number of connection cells as a function of time according to some examples.

FIG. 3 is a schematic circuit diagram of an exemplifying circuit arrangement according to some embodiments herein.

FIG. 4 is a schematic circuit diagram of exemplifying circuit arrangements connected in parallel.

FIG. 5 is a schematic circuit diagram of exemplifying circuit arrangements connected in parallel, with enhanced possibility to control voltage and current.

FIG. 6 is a schematic circuit diagram of exemplifying part of the circuit arrangement, with enhanced possibility to control voltage in small voltage steps.

FIG. 7 is another schematic circuit diagram of exemplifying part of the circuit arrangement, with enhanced possibility to control voltage in small voltage steps.

### DETAILED DESCRIPTION

Throughout the following description, similar reference numerals have been used to denote similar features, such as modules, circuits, parts, items, elements, units or the like, when applicable.

Some embodiments herein provide a circuit arrangement which is designed and configured to control voltage, e.g. over a power unit. The circuit arrangement may be a battery assembly, a battery pack, a rechargeable battery unit, a circuit arrangement comprising battery cells, or the like. The solution described herein provides one or more the following functions and/or advantages: voltage controllability, active cell balancing between cell modules within the circuit arrangement, low implementation cost and low losses in switches of the circuit arrangement.

With a least some embodiments herein, a majority of cells of the circuit arrangement is included in groups of cell modules (strings of directly series connected cells) with a high number of cells (10-50 cells in series, to give typical 30-200V per cell module in case of using Lithium-Ion type of battery cells.). Today, it is believed that 10-16 cells in series will normally be used, but a higher number of cells in series can be foreseen in the future, to further reduce cost and losses. Each cell module is arranged with at least one transistor pair, which can be controlled to make the cell module to be included in the string of series connected battery cells or not. The high number of cells in the cell modules makes both the losses and the cost for the corresponding transistor pair small. This design also fits very well with the cell monitoring circuits available on the market of today, that measures the cell voltage, and some temperatures in the cell module, and makes resistor switched cell balancing within the cell module possible.

According to at least some embodiments herein, the transistor pair will switch as seldom as possible, to reduce the switching losses. Normally a typical switching frequency in the region of 0.01-10 Hz will be used, which will give very low switching losses. During transient conditions such as during changes in load or charging power or in case of ramping up or down the output voltage between the poles of the circuit arrangement, a higher switching frequency than 10 Hz may be used for a short time, such as during one second or a few seconds. The total losses for the transistors including both conduction losses and switching losses, can be designed to be very small, such as 0.1-0.3% of the total power handled by the battery, which is a clear advantage. The terms “conduction losses” and “switching losses” are known in related literature. Briefly, conduction losses are voltages and currents that occur when a switch, such as a MOSFET or the like, is allowing current to pass through it, e.g. the switch is switched on. This is duty-cycle dependent. Switching losses occur when the switch is transitioning between on-state, i.e. allowing current to pass, to off-state, i.e. not allowing current to pass, and vice versa. Switching of the transistor pair will be needed both to regulate the output voltage of the battery as well as to make active cell balancing possible between the cell modules. Both these functions can normally be done at this low switching frequency.

A drawback with only having cell modules with many series connected cells, is that the voltage control resolution will be poor and that large switching transients including very high current peaks will happen if such a cell module is switched into or out from the string of series connected cells, when there is need for changing the output voltage of the battery.

To overcome this drawback, at least one another group of cell modules will be used in the battery, also this cell module with a corresponding transistor pair. This other group of cell modules will have a different number of series connected cells, selected such that the voltage control resolution will be improved, typical at least a factor of two to four better for each group of cell modules which is added. This can be done down to the voltage resolution corresponding to one single cell. Some embodiments also describe a way to achieve a voltage resolution which is less than the voltage across one single cell, which can be of interest in some cases. By improving the voltage resolution, the problem with switching transients is reduced.

How good voltage controllability is needed is application dependent and therefore not specified in this disclosure in detail. Especially good voltage control is needed when connecting batteries in parallel. Here it is an advantage to have a very good voltage resolution, such as 1% or even better, as this improves the possibility to control the current sharing between the batteries. This is due to the fact that most lithium-ion batteries have a very low internal resistance, often in the range of 0.1 ohm for a 400-800V battery, which makes a voltage change of only a few volts to change the current balance between parallel connected batteries by tens of ampere.

The following terms and expressions have been used herein.

Capacity of a circuit arrangement, comprising battery cell modules, is herein defined as the number of available ampere-hours that can be released from a fully charged circuit arrangement, comprising battery cell modules, under specified operating conditions. The term useful capacity is sometimes also used, to determine that the capacity is restricted to avoid that individual cells inside the circuit arrangement is over-charged or under charged. The capacity of a circuit arrangement is normally reduced over time as the battery is ageing or after a number of discharge/charge cycles. State of charge at any time is normally defined on cell level of a circuit arrangement and refers to the dischargeable cell capacity as a percentage value. When the state of charge (SOC) is 100% it means a fully charged cell and 0% means a fully discharged cell or to a defined level which is regarded to be safe. The term “state of charge” may also be used on a circuit arrangement level and in this case the state of charge means the remaining charge that can be discharged from the battery assemble when described as a percentage value. A state of charge of 100% means that the circuit arrangement is fully charged and a state of charge of 0% means that the circuit arrangement is fully discharged or to a defined level which is regarded to be safe. When the battery, such as the battery cells, degrades e.g. due to aging, the capacity in ampere-hour may typically decrease, but the state of charge can still be varying between 100% and 0% depending on how much the circuit arrangement is discharged/charged at a given moment.

State of health may be defined as a percentage indicating the condition of a battery, or a cell, or a battery pack, indicating the remaining capacity in Ah, compared to its ideal conditions, e.g. given by a manufacturing specification. The percentage may depend on e.g. one or more of age of battery, number charging/discharging cycles, how deep each charging discharging cycle has been, temperature during usage etc.

The term “cell module configuration” may refer to whether a particular cell module is contributing or not contributing to the output voltage, i.e., whether the particular cell module is passed, i.e., current goes through it, or if it is bypassed, i.e., current does not go through it. Unless otherwise noted, cell modules herein are discrete in that the cell module is either completely included to contribute to the output voltage or completely excluded to refrain from contribution to the output voltage. That is to say, the cell modules are discretely controlled by the cell module configuration. The cell module configuration may solely indicate a state from among a set of states of each cell module, wherein the set of states comprises a first state indicating that the cell module is included in the series connected set of modules (switched-on), and a second state indicating that the cell module is bypassed and contributing with voltage in the series connected set of modules.

A group of cell modules is defined as a number of cell modules larger or equal to one, where the nominal voltage of each of the cell modules within the group are the same or approximately the same. If same type of cells is used in all cell modules, the number or series connected cells in each cell module belonging to this group are the same.

The term “group configuration” may refer to which cell modules within a group that contribute to the output voltage and which cell modules within the group that do not contribute to the output voltage. By alternating which cell modules that contribute, and which cell modules that do not contribute to the output voltage, active balancing among the cell modules within the group may be achieved.

The term “circuit configuration” may be referred to as “alternative”. A circuit configuration may specify which cell modules of one group within a circuit arrangement that contribute to the output voltage and which cell modules within another group of the circuit arrangement that contribute to the output voltage. By alternating which cell modules of the groups that contribute, and which cell modules that do not contribute to the output voltage, active balancing among the groups within the circuit arrangement may be achieved.

The term “cell module” may refer to a string of battery cells, a set of battery cells, an array of battery cells or the like. In this context, the term “battery cell” may refer to a chemical cell capable of providing voltage and current.

The term “battery module” may comprise one (or more) cell module(s) and an electronic module that is controllable to bypass the cell module such that voltage over the battery module is very small, or substantially zero, or to allow current to pass though the cell module such that voltage over the battery module can be the nominal cell module voltage for the cell module. Sometimes, the battery module may be controllable to switch off the battery module, e.g. disable the battery module, whereby substantially no current is allowed to pass through the battery module.

As used throughout the present disclosure, the term “control unit” may refer to a master control unit, a slave control unit, a battery management system (BMS), an energy storage system (ESS) controller, a controller, a control circuit, a combination thereof or the like.

The term “DC link” or “DC link bus” can be defined as a pair of poles or conductive lines, one positive pole and one negative pole, there batteries, battery arrangements, circuit arrangements, DC loads, DC sources, DC link capacitors and power units, that can act as either loads or sources as a function of time, can be connected.

A target, such as a voltage target, a current target and the like, may refer to a particular target value related to current and/or voltage, optionally including a margin value. By means of the margin value a range from the target value minus the margin value to the target value plus the margin value may be specified. The target may also directly refer to a range or interval for the voltage and/or current. In some cases, a target related to current may be replaced by a target related to voltage, while in some other cases, a target related to voltage may be replaced by a target related to current.

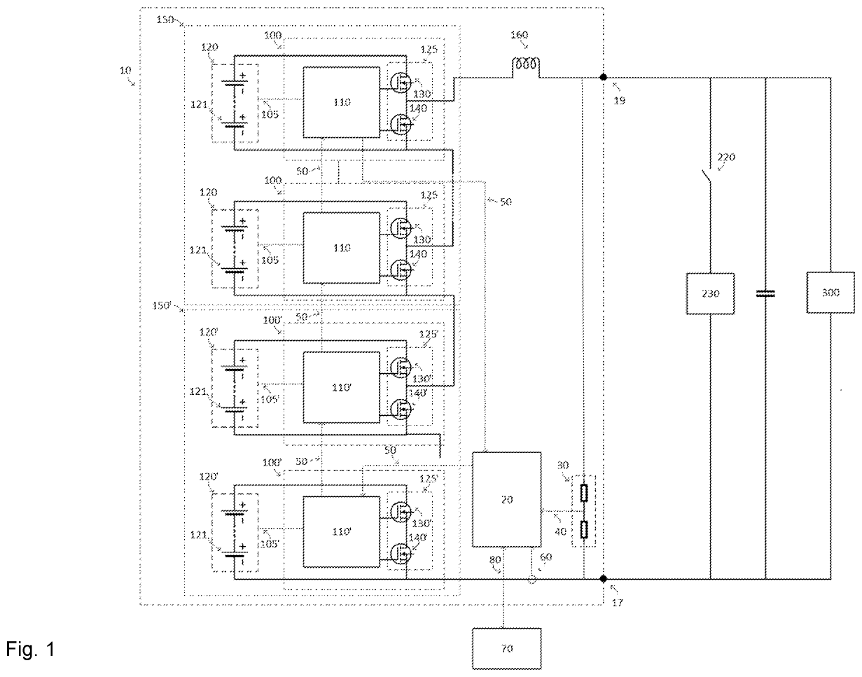

FIG. 1 shows an exemplifying circuit arrangement 10 for controlling an output voltage of the circuit arrangement 10 towards a voltage target for exchange of electric power with an electric power unit 230, 300, e.g. during exchange of electric power or otherwise, i.e. without exchanging electric power with the electric power unit. The electric power unit may be a load 300, a combined load or source 300, a source device 230 or the like. The electric power unit 300 may comprise an inverter and an electric motor that during certain times act as a load and other times acts as a power source. The source device 230 may be a charging station for vehicles, electrical devices, or the like. The circuit arrangement 10 may sometimes be referred to as a circuit arrangement, comprising cell modules, herein. The combined load or source 300 may comprise an electric motor that may be used for driving a vehicle, but which also may be used for generating energy e.g. when the electric motor is used for slowing down the vehicle.

The circuit arrangement 10 is connected to a DC-link capacitor 200 The inductor 160 is representing the total inductance inside the circuit arrangement. Typically, the DC-link capacitor is connected to some type of load or source 300, e.g. an inverter, which may be used to drive an electric motor in e.g. a vehicle or the like. To charge the circuit arrangement 10, there is a charging interface 230, which can deliver charging power to the circuit arrangement after closing the circuit breaker 220, for example while charging the vehicle at a charging station. The source device 230, or charging device, can also represent other electric power sources such as for example a fuel cell that can deliver electric power to the DC-link (battery assembly and inverter) while driving or a charging line connected to the vehicle during driving (electric road application). Each of the cell modules 120, 120′ is connected to a respective electronic module 100, 100′ that includes a number of specialized IC circuits and other electronic components. One such IC circuit is a cell monitoring circuit (prior art), which is included in the electronic circuit 110, 110′. The electronic circuit 110, 110′ includes besides the cell monitoring circuit also drivers for the transistors 130, 130′, 140, 140′ and may also include other electronic components. Accordingly, any control signals may be expressed as sent to, or received by, the electronic module 100, 100 or the electronic circuit 110, 110′. The cell monitoring circuit monitors the cell voltage of each battery cell and the temperature in a number of points inside the cell module 120, 120′. The cell monitoring circuit often also includes means for resistor switched cell balancing, which means that a resistor can be switched in parallel to the cells that has a higher state of charge as compared to other cells in the cell module 120, 120′. The connection between the cell monitoring circuit inside the electronic circuit 110, 110′ and the cell module 120, 120′ is indicated by the dotted line 105, 105′. The cell monitoring circuit also includes means for communication with a control unit 20 via a communication line 50, in this figure indicated as a daisy chain link. This communication line can be arranged in many other ways, such as using optical communication or radio link communication. The control unit 20 will use the information from each cell monitoring circuit to calculate various cell parameters as State of Charge, State of Power, State of Temperature, State of Health etc. (prior art). Instead of calculating these State parameters inside the control unit 20, the information from each cell monitoring circuit can be provided to another control unit, such as an ESS, that perform these calculations. The control unit can also initiate cell balancing using switched resistors when there is need for this (prior art). The circuit arrangement comprises a pair of terminals 17, 19 for connection of the circuit arrangement to an electric power unit 230, 300. The output voltage between the pair of terminals 17, 19 is controllable, e.g. when exchanging electric power with the electric power unit 230, 300, but also otherwise. One of the terminals 19 is a plus pole and the other terminal 17 is a minus pole.

The circuit arrangement 10 comprises: battery cells 121 forming a plurality of series-connectable cell modules 120, 120′. Each series-connectable cell module 120, 120′ is connected to a respective electronic module 100, 100′ controllable to include said each cell module 120, 120′ for contribution to the output voltage or to bypass said each cell module 120, 120′ for exclusion from contribution to the output voltage. In one example, the circuit arrangement 10 includes a large number of battery cells. The battery cells are connected into cell modules 120, 120′ where each cell module includes at least one cell, but normally a plurality of series connected cells. Each battery cell inside the cell module can either be a single cell or represent a number of parallel-connected cells to make each group of parallel connected cells in the cell module to have a certain Ah rating or a certain power rating.

The electronic circuit 110, 110′ also includes a driver for at least one transistor pair 125, 125′ arranged in half-bridge configuration including at least two transistors 130, 130′, 140, 140′. The transistors are normally included in an electronic module 100, 100′ together with the electronic circuit 110, 110′. The transistors are normally N-channel power MOSFETs (Metal-Oxide-Semiconductor Field-Effect Transistor) but can also be another type of transistor. Each MOSFET in the pair can be in two states, either on or off. If the upper MOSFET 130, 130′ is on and the lower MOSFET 140, 140′ is off, the cell module 120, 120′ is included in the string of series connected cells of the circuit arrangement 10. If the upper MOSFET 130, 130′ is off and the lower MOSFET 140, 140′ is on, the cell module 120, 120′ is bypassed and not included in the string of series connected cells of the circuit arrangement 10. This is called “state of the transistor pair”. There may also be a third state, i.e., “Disable state”, where both transistors 130, 130′, 140, 140′ is controlled to off. In this case the current through the circuit arrangement will flow through internal diodes of the transistors 130, 130′, 140, 140′. The Disable state is normally commanded to all the electronic modules 100, 100′, e.g. in more detail to the electronic circuits 110, 110′, at the same time, to reduce the current in the circuit arrangement 10 quickly to zero in case the circuit arrangement needs to be disconnected quickly from the energy storage system. In case the Disable state is commanded during charging, the charging current will flow through the internal diode 130, 130′ of the transistor pairs, resulting in an increased voltage, as all cell modules will be connected through the diodes. It is here important that the charger has a voltage limit and that the voltage of the circuit arrangement in Disable state is higher when this voltage limit. In this case the charging current will fall quickly to zero without overheating the internal diodes and the current drops to zero. In case the Disable state is commanded during discharging, the discharging current will flow through the internal diode 140, 140′ of the transistor pairs, resulting in a decreased voltage, as all cell modules will be bypassed. This will also result in that the discharging current falls to zero.

The control unit 20 is used to control the state of each transistor in the circuit arrangement, using the communication line 50 and possibly also using other not shown communication lines between the control unit 20 and the electronic module 100, 100′. One example is to use a second signal (synch/enable signal) from the control unit to each electronic module 100, 100′ that delivers information of if the transistors shall be in Disable state (both off) or in Enable state (included or bypassed state) and a synchronization pulse or triggering pulse telling the exact timing to change state of the transistors in each of the electronic modules 100, 100′.

According to the embodiments herein, the control unit 20 is configured to control how many cells in total is connected in series as a function of time. The reason for changing the number of series connected cells can be due to many reasons. One reason is to control the total voltage between the poles 19 (positive pole) and pole 17 (negative pole) of the circuit arrangement or the voltage VDC across the DC link capacitor 200. The voltage between the poles is measured by a voltage divider 30 and indicated to the control unit by a voltage signal 40. The voltage set point can be delivered to the control unit 20 from a primary control unit, such as an ESS control unit or the like, or can also be programmed into one of the control units, 20, 70.

For a fixed number of cells connected in series, the voltage will vary due to many reasons, such as State of Charge of the individual battery cells, temperature of the battery cells that may cause a large variation of the internal resistances in the cells, ageing of the battery cells, current direction through the cells, load current delivered by the circuit arrangement or charging current delivered to the circuit arrangement. This is also known from prior art that it can be beneficial to reduce the voltage variance of such a circuit arrangement, by changing the number of cells connected in series. According to one example, the voltage control is performed with the following setup.

The cell modules 120, 120′ comprise:
a first group of cell modules 150 comprising a first number of cell modules 150. Each cell module 120, 120′ of the first group has a first nominal cell module voltage in a range of 30-200 V, and.
At least one second group of cell modules 150′ comprising a second number of cell modules 150′. Each cell module 120, 120′ of said at least one second group has a second nominal cell module voltage that is less than the first nominal cell module voltage.

The first number may be different from the second number or the first and second numbers may be equal, as will be seen from the examples herein. The group having the highest nominal cell module voltage among the groups is referred to as the first group.

Moreover, the circuit arrangement 10 comprises a control unit 20 configured to: measure the output voltage of the circuit arrangement 10, and in order to control the measured output voltage towards the voltage target, control at least one respective electronic module 100, 100′ to adjust a respective contributing number of cell modules 120, 120′ of at least one of the first and second groups. Each cell module 120, 120′ of the respective contributing number of cell modules 120, 120′ is contributing, positively or negatively, to the output voltage of the circuit arrangement 10.

Expressed differently, the circuit arrangement 10 is divided into a number of battery groups 150, 150′, where the number of groups are at least two.

The first group 150 may in one example comprise an absolute majority of the battery cells comprised in the circuit arrangement 10. It may be noted that a total number of battery cells that are connectable in series, can be very large, for example if a circuit arrangement shall be designed to handle up to 1200V charging voltage, the number of series connected cells can be more than 300 cells in series. In this group, the number of series-connected cells in the cell modules 120 are large, typically between 10 and 16, preferably between 12 and 16. One reason for the number of 16 is that many cell monitoring circuits existing on the market today is limited to maximum 16 cells. Another reason is that the total voltage across a cell module is often limited to 60V DC, for electrical safety reasons, which is preferred during assembly and service of cell modules. The number of series connected cells is also dependent of the cell chemistry and type of cells used in the cell modules there many Lithium-ion battery cell chemistries today has a nominal voltage between 3.3V and 3.7V. There are also cells with lower cell voltage such as for example Lithium Titanate cells (LTO) which has a cell voltage of typical 2.3-2.5V. In this case 18-24 cells can be used in series without exceeding 60V DC.

It may be noted that even if it is common today to design cell modules with a voltage of less than 60V DC as this will simplify assembly and service, it is fully possible to also design a cell module for a higher voltage than 60V DC such as 100V, 150V or even 200V, which in this case will incorporate many more cells in series. It can in fact in some cases be advantageous to make such a design, as this can reduce number of components, cost and losses for the total system.

In the first group 150, using cell modules with less voltage than 60V DC, the switching transistors used are typically silicon MOSFETs, for example 40V to 100V MOSFETs which are very effective from loss point of view, cost point of view and power handling capability. In case of using a first group with a higher max voltage rating than 60V DC, such as for example up to 200V DC, higher voltage silicon MOSFETS or GaN or SiC transistors with higher voltage rating than the max cell module voltage can be a good alternative. Also, other type of transistors can be used as well as new transistor types that will be available on the market in the coming years.

The exact number of cells connected in series in the first cell module 150 will be dependent on several factors such as available transistor technology, mechanical constraints, the number of groups of cell modules to be used, battery cell variation within each cell module over the lifetime, cost and loss optimization etc. The optimum value for a certain application can change over time as both battery cell technology and transistor technology evolve.

The second group 150′ may in one example comprise a much smaller number of series connected battery cells. If for example the number of cells in the cell module 120 is selected to be 12, and the total number of series connected cells in the total circuit arrangement is desired to be controlled to a precision of 2, a minimum of 5 number of cell modules 120′, with 2 cells each, can be used. This means that the battery group 150′, in this case can be controlled to have 0, 2, 4, 6, 8, or 10 series connected cells. If we would like to control the number of cells to a precision of 3, we can use minimum of 3 cell modules 120′, with 3 cells each. This means that the battery group 150′, in this case can be controlled to have 0, 3, 6, or 9 series connected cells.

It may be noted that it can be advantageous to use a higher number of cell modules of type 150′, than the minimum number. By using a higher number of cell modules than the minimum number required, redundancy can be achieved, which means that one or several cell modules can be constantly bypassed, without effecting the possibility to control the output voltage of the circuit arrangement to the precision that is required. Redundancy can be a good way to achieve a high availability of the circuit arrangement, which can be required. Also, a higher number of cell modules than the minimum required, can be advantageous from cell balancing point of view, as there will in this case be more possibilities to reach a certain output voltage, which make it easier to optimize and fully utilize the usage each of the cell modules in the second battery group 150′. The drawback with more cell modules than the minimum number is that this will require a higher number of transistors in series, higher losses and potentially higher cost. This optimization is dependent on requirements for the specific application.

In the example above it is also possible to control the number of series-connected cells to a higher precision, such as 1, by using a minimum number of 11 cell modules 120′ with 1 cell each. However, in case there is need for controlling the number of series connected cells to the precision of 1, it is normally preferred to use a third battery group and possibly also a fourth group, not shown in the FIG. 1. In the example above with a cell module 120 with 12 cells in series, one preferred choice can be to use minimum 3 cell modules 120′ with three series connected cells each and minimum two cell modules 120″ (not shown in the figure) with 1 cell each. In this case only 5 pair of switching transistors can be used to control the number of series connected cells to a precision of 1 instead of using 11 transistor pairs, as in the example above.

The number of groups with different voltage rating of the cell modules, is not restricted to two or three. The number of groups can be higher than three, dependent on how many series connected cells is used in the cell module of the first group and to what voltage precision the output voltage needs to be controlled.

It can also be pointed out, that one or several of the switching modules 100′, can instead of using a half-bridge configuration with one pair of switching transistors, be configured to include a full bridge configuration with four transistors, which means that a fewer number of cell modules can be used, as each full bridge circuit in this case can change the number of series connected cells within the circuit arrangement with both a negative value, zero and a positive value. The usage of a full bridge configuration can have both advantages and disadvantages from cell balancing point of view and the optimal choice can be application dependent. One advantage with using a full bridge is that this cell module can be both charged, bypassed or discharged independent of the current direction for the full circuit arrangement, which gives new possibilities to use cell modules with one or a few cells with a much lower Ah rating than the other cell modules for voltage control.

It can also be pointed out that the cells in the different cell modules in the different groups does not need to be of same type or chemistry or of same nominal voltage rating. As the purpose is to control the output voltage and the cell monitoring circuit always monitors all cell voltages in the stack, the control unit can calculate the total output voltage in the stack of series connected cells. In case a very high precision of output voltage is needed, it can even be an advantage to use one last group of cell modules with very low output voltage for the finest control of the output voltage. Also supercapacitors (sometimes called ultracapacitor or double layer capacitor) can be used in this application instead of using conventional rechargeable battery cells, with the benefit of that in principle any voltage can be reached this way, even voltages lower than 1V as such capacitors can store lots of energy also at very low voltage.

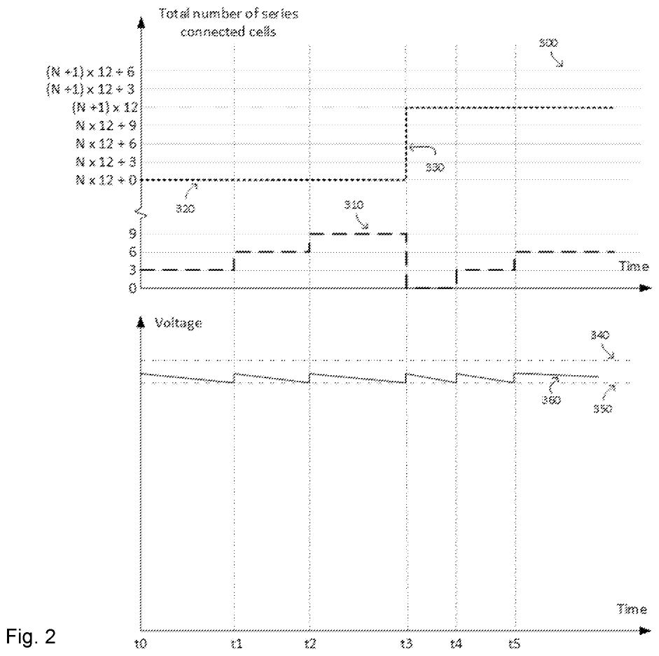

In FIG. 2, it is described more in detail how the number of series connected cells can be controlled, to make the output voltage of the circuit arrangement to be controlled to a certain preferred voltage band, to reduce an error between output voltage and the voltage target to below a certain voltage threshold or even to minimize the error. In this example the number of cells in the cell module 120 is 12 and the number cells in the cell module 120′ is 3.

At a time t0, N number of cell modules of type 120 out of total M number of cell modules of type 120 is included in the string of series-connected battery cells as indicated by the dotted line 320. At this time t0, 1 cell module 120′ with 3 cells is connected to the string of series connected strings as indicated by the line 310. This means that there are totally N×12+3 cells included in the series-connection as indicated by the solid line 300.

The control unit 20 is measuring the output voltage of the circuit arrangement 10 and is comparing the measured voltage 360 with a preferred voltage range. The measured voltage 360 can either be measured inside the circuit arrangement 10, between the poles 19 and 17 by the voltage divider 30 or measured across the DC link capacitor 200. The voltage range has in this case an upper threshold value 340 and a lower threshold value 350. The preferred voltage range is normally delivered to the control unit 20 from another control unit. Instead of delivering an upper and lower threshold value a target voltage level can be delivered, and the control unit 20 can be programmed to minimize the error to this target voltage. The target voltage can change over time and can have different values during charging and during discharging of the circuit arrangement. When energizing the DC-link capacitor or when de-energizing the DC-link capacitor, the target voltage can change as a function of time more rapidly.

The control unit 20 is comparing at regular basis the measured voltage with the lower and upper threshold value (or a single voltage target value). This can be done for example every 10 ms. Normally the voltage will be inside the preferred voltage range and there is no reason to change the total number of series-connected cells. At normal load situations or constant load it can take many seconds or even minutes before there is need for changing the number of series connected cells. This normally depends on the load profile versus time as load changes will be the most common reason for changing the number of series connected cells. At constant load situations, the voltage drop can instead be due to changes in state of charge of the cells which normally results in a lower output voltage of each cell as a function of time. Also changes in cell temperature can slowly change the output voltage.

At a time t1, the measured voltage has dropped to the lower threshold value 350. The control unit will detect the deviation from the preferred voltage and send a control signal to one of the electronic modules 100′ in which the cell module 120′ is bypassed to command said cell module to be included in the series connected string of cells, which is done by turning off transistor 140′ and turning on transistor 130′ of this electronic module 100′. The total number of series connected cells is now increased to N×12+6 and the output voltage of the circuit arrangement is now again within the preferred voltage band.

At the time t2, this is repeated again, and the total number of series connected cells is now increased to N×12+9. Now, in this example, all the cell modules of type 120′ is now connected to the string of series-connected cells.

At the time t3, the measured voltage 360 has again dropped to the lower threshold value 350. The control unit 20 will now again increase the number of series connected cells, with the number of three. This is done by sending a command to one of the electronic modules 100, where the cell module 120 is in a bypassed mode, to make the electronic module ready to change state to “switch-on” state (this information is latched into the electronic module). The control unit 20 is also sending a command to all three of the electronic modules 100′, to be ready to change state to “bypass” state. Also this information is latched into the electronic modules 100′. A trigger signal (or synch signal) is now sent to all the electronic modules 100, 100′ and the latched information is now executed at the same time and the corresponding switches 130, 140, 130′ and 140′ is changing state. This results in that the total number of series connected cells in the circuit arrangement is increased to (N+1)×12.

The procedure at the time t4 and t5 is similar as at t1 and t2.

In case the upper voltage threshold 340 would be reached, the number of series connected cells will instead be controlled by the control unit 20 to decrease in steps of a three in similar way as already described.

This type of control principle can also be used in the case there the number of total series-connected cells can be controlled to a precision of 1, 2, 3, 4 cells or any other integer value according to earlier description.

In some cases, the control unit can also use the measured current 60 shown in FIG. 1 to or from the battery to enhance the output voltage control of the circuit arrangement during transients. This is explained more in detail below.

As an example, a circuit arrangement 10 is controlled to deliver an output voltage of approximately 800V at a load current of 200 A to an inverter/electric motor 240, 250. The average cell voltage is at this point in time 3.6V per cell at a load current of 200 A passing the cells. The control unit 20 has connected 18 cell modules with 12 cells each and two cell modules of 3 cells each to the string of series connected cells, totally 18×12+6=222 cells, resulting in a total voltage of 222×3.6V=799.2 V In this example, voltage drop due to transistors and cables inside the circuit arrangement is neglected to make the example less complex. The inverter is now controlled to reduce the load current quickly to zero. In this example, each cell has an internal resistance of 0.5 mOhm, using a very simple model of the battery cell using only one resistor. This means that the total internal resistance in the circuit arrangement is 222×0.5 mOhm=111 mOhm. The total resistive voltage drop inside circuit arrangement will in this case be 200 A×111 mOhm=22.2 V. This means that the output voltage of the circuit arrangement will rise more than 20V due to the loss of load current due to change in resistive voltage drop. In case the inverter would change the power direction from loading to active breaking, charging the circuit arrangement with for example 200A, the output voltage of the circuit arrangement will increase with nearly 45V.

As such load changes can happen rather quickly, such as within 100 ms, it can be advantageous to detect such a load change and regulate the number of cells connected in series quickly to adapt to the change in current. The voltage divider is however not measuring only the total cell voltage at a certain current but also inductive voltages inside the circuit arrangement appearing during load changes. Assuming that the inductance inside circuit arrangement is approximately 5 μH and the current derivative is 2-4 kA/s, the inductive part of the measured voltage, would be 10-20V, trying to maintain the current flowing into the DC-link capacitor. This means that it will take some time before the control unit detects the current change if the control unit only uses the measured voltage as input. By using also current measurement and proper modelling of the circuit arrangement including estimation of internal resistances and inductances inside the circuit arrangement a better and faster control of the voltage of the DC link capacitor can be achieved. Such modelling may be achieved using physical knowledge (i.e., electronics) which gives us so called “white boxes”, or it may be achieved using dynamic models such as auto regressive (AR) or moving average (MA) modelling or combination thereof, or any other dynamic model that provides the degrees of freedom necessary to capture the dynamics of the system, so called black box modelling. The literature is rich in description of available models and how to identify the parameters and order thereof, so called system identification theory.

Table 1 below illustrates two further examples of how two groups of cells modules can be combined to control the output voltage down to a voltage resolution corresponding to 3 cells. Our target is in this example to produce a DC voltage output of 600V+/−6V from a set of totally 240 cells, while using the circuit arrangement for driving a vehicle. In this example, the cell voltage will be within the span of 3.0V-4.0V for all specified state of charge levels for the cells, specified cell temperatures and in the specified current range considering during both loading the circuit arrangement and charging the circuit arrangement during generative breaking, also considering normal ageing of cells.

As our target is to produce 600V in all conditions, we can calculate that we will need between 150-200 series connected cells to do this or more correct between 150 and 201 cells, as we only can combine cell modules to reach a total number of cells with a resolution of 3. By using in total 240 cells, this gives us a large margin for making this possible also with some modules out of order.

In a first design case, the cell modules in the first group have 15 cells each and the cell modules in the second group have 12 cells each. We assume that the total number of available cells are 240. 120 cells are used in the first group, divided into 8 cell modules with 15 cells each and the second group has 10 cell modules with 12 cells each. This is an example of embodiments, wherein the first nominal cell module voltage corresponds to a first number of battery cells in a range of 10-50 cells, preferably 12-40 cells and most preferably 12-20 cells.

The first design is also an example of embodiments, wherein the second nominal cell module voltage differs from the first nominal cell module voltage by a difference voltage corresponding to 1 to 4 battery cells, e.g. 15 cells-12 cells=3 cells. With this design, the first and second groups both have a relatively large number of cells, where the difference in number of cells allows for fine adjustment, in the order of 1 to 4 cells, in particular ranges.

Moreover, the first design is an example of embodiments, wherein, the first number of cell modules 120, 120′ and the second number of cell modules 120, 120′ provides a resolution for number of series-connectable battery cells 121, in at least one sub-range of an operating range of the circuit arrangement 10 of 1 to 4 battery cells 121. The operating range may include no contributing cell modules up to that all cell modules of the first and said at least one second group are contributing to the output voltage. In a second design case, the cell modules in the first group have 15 cells each and the cell modules in the second group have 3 cells each. This is an example of that, according to some embodiments, a first contribution sum of each respective voltage of each cell module 120, 120′ among the respective contributing number of cell modules 120, 120′ of the first group matches the voltage target. Any difference between the voltage target and the first contribution sum is matched by a second contribution sum of each respective voltage of each cell module 120, 120′ among the respective contributing number of cell modules 120, 120′ of said at least one second group. In this manner, cell modules of the first and second groups are used to arrive at, or near the voltage target.

The second design is also an example of embodiments, wherein the second nominal cell module voltage corresponds to a second number of cells that is less than half the first number of cells. As seen in the second design, the second number of cells is 3 and the first number of cells is 15. Since, 3 is less than 15/2, this is a valid example.

Furthermore, the second design is also an example of embodiments, wherein the first number of cells divided by the second number of cells equals an integer that is greater than two. The second design yields that 15/3 is 5, which is an integer greater than 2. In one other example, the case may be that 15/5 is 3, which still is greater than 2. In this example, the second number of cells is 5 (and the first number of cells remains at 15).

We assume that the total number of available cells are 240. 225 cells are used in the first group, divided into 15 cell modules with 15 cells each and the second group has 5 cell modules with 3 cells each. Furthermore, assuming that a nominal cell voltage of all cells in this example is e.g. 3 V. Then, with this assumption, there is provided an example of that the second number of cell modules 120, 120′ increased by one, i.e. 5+1=6, and then multiplied by the second nominal cell module voltage, e.g. 3*3=9, corresponds to, or is greater than, the first nominal cell module voltage.

The first nominal cell module voltage is with this example 3 V*15 cells=45 V. 6*9 V=54 V, which is greater than 45 V.

In this manner, a finest possible resolution may be achieved, given the first and second nominal cell voltages. Here, resolution refers to a size of steps in voltage that the circuit arrangement 10 may provide.

We can see in the table below that for a certain number of total cells connected in the series, there are two different alternatives possible (marked in grey in the table below), to reach the requested output voltage. For these operating conditions, there are a possibility to change how much the cells within group one and group two are utilized. These operating conditions gives an opportunity of balancing the state of charge between the cell modules in the different groups. For the second design case these conditions are slightly better distributed which can give some advantage, but there are also other possibilities to do this charge balancing in case the voltage stability requirement can be reduced slightly.

TABLE 1

| | |
|---|---|
| Alternative 1 | Alternative 2 |

| | | | | |
|---|---|---|---|---|
| No of total | No of cell | No of cell | No of cell | No of cell |
| cells | modules | modules | modules | modules |
| connected | used in | used in | used in | used in |
| in series | group 1 | group 2 | group 1 | group 2 |

Design 1
Group 1 = 8 modules × 15 cells
Group 2 = 10 modules × 12 cells

| | | | | |
|---|---|---|---|---|
| 150 | 6 | 5 | 2 | 10 |
| 153 | 7 | 4 | 3 | 9 |
| 156 | 8 | 3 | 4 | 8 |
| 159 | 5 | 7 | | |
| 162 | 6 | 6 | | |
| 165 | 7 | 5 | 3 | 10 |
| 168 | 8 | 4 | 4 | 9 |
| 171 | 5 | 8 | | |
| 174 | 6 | 7 | | |
| 177 | 7 | 6 | | |
| 180 | 8 | 5 | 4 | 10 |
| 183 | 5 | 9 | | |
| 186 | 6 | 8 | | |
| 189 | 7 | 7 | | |
| 192 | 8 | 6 | | |
| 195 | 5 | 10 | | |
| 198 | 6 | 9 | | |
| 201 | 7 | 8 | | |

Design 2
Group 1 = 15 modules × 15 cells
Group 2 = 5 modules × 3 cells

| | | | | |
|---|---|---|---|---|
| 150 | 9 | 5 | 10 | 0 |
| 153 | 10 | 1 | | |
| 156 | 10 | 2 | | |
| 159 | 10 | 3 | | |
| 162 | 10 | 4 | | |
| 165 | 10 | 5 | 11 | 0 |
| 168 | 11 | 1 | | |
| 171 | 11 | 2 | | |
| 174 | 11 | 3 | | |
| 177 | 11 | 4 | | |
| 180 | 11 | 5 | 12 | 0 |
| 183 | 12 | 1 | | |
| 186 | 12 | 2 | | |
| 189 | 12 | 3 | | |
| 192 | 12 | 4 | | |
| 195 | 12 | 5 | 13 | 0 |
| 198 | 13 | 1 | | |
| 201 | 13 | 2 | | |

In the next example shown in table 2 we will study how both of these designs would behave during charging from a high voltage charging station that can provide a charging voltage up to e.g. 1000V. Here we would like to use as high charging voltage as possible, to reduce the charging time and ensure that we can charge all cell modules to an appropriate charging level. We assume in this example that the average cell voltage at fast charging will be in-between 3.2V and 4.0V. In other examples, the average cell voltage may be outside this range.

From table two we can conclude that both designs work good in this respect. Using 225 cells in series, up to approximately 900V can be used during charging the vehicle in both cases.
In both design 1 and design 2 the circuit arrangement can for example start charging with all 240 cells connected in series.
For design 1 it is possible to reduce the number of series connected cells to 225 resp. 228 cells after some time, as these two alternatives gives an opportunity to do active cell balancing between all cell modules in both groups.
For design 2 it is possible to reduce the number of series connected cells to 222 resp. 225 cells in series after some time (two alternatives for 225 cells), and these three alternatives gives an opportunity to do active cell balancing between all cell modules.
Design 2 gives one benefit in terms of that the voltage disturbance on the DC bus that will happen when reducing the number of series connected cells from 240 cells to 225 cells will be smaller than for design 1.

TABLE 2

| | |
|---|---|
| Alternative 1 | Alternative 2 |

| | | | | |
|---|---|---|---|---|
| No of total | No of cell | No of cell | No of cell | No of cell |
| cells | modules | modules | modules | modules |
| connected | used in | used in | used in | used in |
| in series | group 1 | group 2 | group 1 | group 2 |

Design 1
Group 1 = 8 modules × 15 cells
Group 2 = 10 modules × 12 cells

| | | | | |
|---|---|---|---|---|
| 180 | 8 | 5 | 4 | 10 |
| 183 | 5 | 9 | | |
| 186 | 6 | 8 | | |
| 189 | 7 | 7 | | |
| 192 | 8 | 6 | | |
| 195 | 5 | 10 | | |
| 198 | 6 | 9 | | |
| 201 | 7 | 8 | | |
| 204 | 8 | 7 | | |
| 207 | | | | |
| 210 | 6 | 10 | | |
| 213 | 7 | 9 | | |
| 216 | 8 | 8 | | |
| 219 | | | | |
| 222 | | | | |
| 225 | 7 | 10 | | |
| 228 | 8 | 9 | | |
| 231 | | | | |
| 234 | | | | |
| 237 | | | | |
| 240 | 8 | 10 | | |

Design 2
Group 1 = 15 modules × 15 cells
Group 2 = 5 modules × 3 cells

| | | | | |
|---|---|---|---|---|
| 180 | 11 | 5 | 12 | 0 |
| 183 | 12 | 1 | | |
| 186 | 12 | 2 | | |
| 189 | 12 | 3 | | |
| 192 | 12 | 4 | | |
| 195 | 12 | 5 | 13 | 0 |
| 198 | 13 | 1 | | |
| 201 | 13 | 2 | | |
| 204 | 13 | 3 | | |
| 207 | 13 | 4 | | |
| 210 | 13 | 5 | 14 | 0 |
| 213 | 14 | 1 | | |
| 216 | 14 | 2 | | |
| 219 | 14 | 3 | | |
| 222 | 14 | 4 | | |
| 225 | 14 | 5 | 15 | 0 |
| 228 | 15 | 1 | | |
| 231 | 15 | 2 | | |
| 234 | 15 | 3 | | |
| 237 | 15 | 4 | | |
| 240 | 15 | 5 | | |

Now we will describe one further example, where the voltage resolution is improved, corresponding to the voltage across one cell.

In table 3, a design 3 is outlined, still with 240 cells in total, with the following configuration:
A first group, consisting of 13 cell modules with 15 cells each
A second group, consisting of 3 cell modules, with 6 cells each
A third group, consisting of 3 cell modules, with 5 cells each
A fourth group, consisting of 3 cell modules, with 4 cells each

Totally this design includes 22 cell modules. It is possible to make a design with less modules in total, still making it is possible to control the voltage corresponding to one cell resolution, but this design has redundant ways of achieving a certain number of series connected cells, which means it is tolerant for faults in the chain, with possibility to bypass faulty modules without losing the voltage controllability resolution.

It can be pointed out, that some embodiments herein allow the cell modules to be connected via the transistor pairs in any order. So in this case it can for example be practical to combine one 6 cell module, one 5 cell module and one 4 cell module in one unit, including 15 cells, even if this unit consists of three different groups.

TABLE 3a
Design 3
Group 1: 13 modules × 15 cells
Group 2: 3 modules × 6 cells
Group 3: 3 modules × 5 cells
Group 4: 3 modules × 4 cells

| | Alternative 1 | | | | Alternative 2 | | | |
|---|---|---|---|---|---|---|---|---|
| No of | No of cell | No of cell | No of cell | No of cell | No of cell | No of cell | No of cell | No of cell |
| total | modules | modules | modules | modules | modules | modules | modules | modules |
| cells | used in | used in | used in | used in | used in | used in | used in | used in |
| in series | group 1 | group 2 | group 3 | group 4 | group 1 | group 2 | group 3 | group 4 |
| 195 | 11 | 2 | 2 | 2 | 12 | 1 | 1 | 1 |
| 196 | 11 | 2 | 3 | 1 | 12 | 2 | 0 | 1 |
| 197 | 11 | 3 | 2 | 1 | 12 | 2 | 1 | 0 |
| 198 | 11 | 1 | 3 | 3 | 12 | 0 | 2 | 2 |
| 199 | 11 | 2 | 2 | 3 | 12 | 1 | 1 | 2 |
| 200 | 11 | 3 | 1 | 3 | 12 | 2 | 0 | 2 |
| 201 | 11 | 3 | 2 | 2 | 12 | 2 | 1 | 1 |
| 202 | 11 | 3 | 3 | 1 | 12 | 2 | 2 | 0 |
| 203 | 12 | 1 | 1 | 3 | 13 | 0 | 0 | 2 |
| 204 | 12 | 1 | 2 | 2 | 13 | 0 | 1 | 1 |
| 205 | 12 | 2 | 1 | 2 | 13 | 1 | 0 | 1 |
| 206 | 12 | 2 | 2 | 1 | 13 | 1 | 1 | 0 |
| 207 | 12 | 3 | 1 | 1 | 13 | 2 | 0 | 0 |
| 208 | 12 | 1 | 2 | 3 | 13 | 0 | 1 | 2 |
| 209 | 12 | 1 | 3 | 2 | 13 | 0 | 2 | 1 |
| 210 | 12 | 2 | 2 | 2 | 13 | 1 | 1 | 1 |
| 211 | 12 | 2 | 3 | 1 | 13 | 2 | 0 | 1 |
| 212 | 12 | 3 | 2 | 1 | 13 | 2 | 1 | 0 |
| 213 | 12 | 1 | 3 | 3 | 13 | 0 | 2 | 2 |
| 214 | 12 | 2 | 2 | 3 | 13 | 1 | 1 | 2 |
| 215 | 12 | 3 | 1 | 3 | 13 | 2 | 0 | 2 |

It can be concluded that in all cases shown in table 3a, there will be at least 2 alternatives to choose from, which means that it will be possible to reach a resolution of one cell also with one cell module bypassed due to failure of this cell module.

TABLE 3b
Design 3
Group 1: 13 modules × 15 cells
Group 2: 3 modules × 6 cells
Group 3: 3 modules × 5 cells
Group 4: 3 modules × 4 cells

| | Alternative 3 | | | | Alternative 4 | | | |
|---|---|---|---|---|---|---|---|---|
| No of | modules | modules | modules | modules | modules | modules | modules | modules |
| total | used in | used in | used in | used in | used in | used in | used in | used in |
| cells | group 1 | group 2 | group 1 | group 2 | group 1 | group 2 | group 1 | group 2 |
| in series | No of cell | No of cell | No of cell | No of cell | No of cell | No of cell | No of cell | No of cell |
| 195 | 13 | 0 | 0 | 0 | 10 | 3 | 3 | 3 |
| 196 | | | | | | | | |
| 197 | | | | | | | | |
| 198 | | | | | | | | |
| 199 | 13 | 0 | 0 | 1 | | | | |
| 200 | 13 | 0 | 1 | 0 | 11 | 2 | 3 | 2 |
| 201 | 13 | 1 | 0 | 0 | | | | |
| 202 | | | | | | | | |
| 203 | | | | | | | | |
| 204 | 11 | 2 | 3 | 3 | | | | |
| 205 | 11 | 3 | 2 | 3 | | | | |
| 206 | 11 | 3 | 3 | 2 | | | | |
| 207 | | | | | | | | |
| 208 | | | | | | | | |
| 209 | | | | | | | | |
| 210 | 14 | 0 | 0 | 0 | 11 | 3 | 3 | 3 |
| 211 | | | | | | | | |
| 212 | | | | | | | | |
| 213 | | | | | | | | |
| 214 | 14 | 0 | 0 | 1 | | | | |
| 215 | 14 | 0 | 1 | 0 | 12 | 2 | 3 | 2 |

Table 3b is a continuation of Table 3A, showing that in some cases there is three or 4 alternative possible to reach a certain number of series-connected cells. This is not only good from redundancy point of view. Two or more alternatives can be used for active cell balancing. How this is done will be explained below.

The control unit 20 according to FIG. 1, will not only deal with voltage control, it will also do active cell balancing between the cell modules.

A control principle is described here, about how active cell balancing can be done within each group of cell modules and between groups of cell modules.

First, to make active cell balancing possible between cell modules within one group the following is needed:
We need a load current or a charging current.
We need the load current or charging current to pass at least one cell module or to have at least one cell module in the group bypassed from the load current/charging current.

Second, we need a method to control the average State Of Charge (SOC) of the cells in each cell module. There is a number of ways to estimate State Of Charge of battery cells and group of battery cells (state of art). We call such a function for a State Of Charge estimator or shorter SOC estimator. Assume that there is an SOC estimator that within certain time intervals update the average SOC values for each cell module and the SOC variation between the cells around the average value within each cell module. The control unit (20) will measure the current (60) passing the Circuit

Arrangement (10) with a certain timing resolution and can also determine in which state the Transistor Pair (125, 125′) is for each of these times, which means that the control unit can determine the charge passing each of the cell modules (120, 120′) as a function of time to update the SOC estimator with this information.

The basic cell balancing algorithm described here is based on balancing the charge passing each cell module within a group of cell modules. This algorithm can be further improved also taking into account that the cells can have different State of Health (charge that can be utilised within a load/charging cycle) due to ageing etc. and thus different cell modules may be controlled so they are utilized less than other cell modules.

This means that active cell balancing is used to make the individual cell modules to be controlled individually to their average target SOC value, where the average Ah rating corresponding to 100% SOC can vary from cell module to cell module.

In our case, we need both to control the output voltage and at the same time make active cell balancing between the cell modules in one group. We would like to do this, with a small number of switching events of the transistor pairs, to reduce switching losses and transients caused by these switching events.

Now, assume that the number of series connected cells at a certain time is 215 according to table 3. This case is shown again in Table 4 below.

TABLE 4
Design 3
Group 1: 13 modules × 15 cells
Group 2: 3 modules × 6 cells
Group 3: 3 modules × 5 cells
Group 4: 3 modules × 4 cells

| No of | No of cell | No of cell | No of cell | No of cell | No of cell | No of cell | No of cell | No of cell |
|---|---|---|---|---|---|---|---|---|
| total | modules | modules | modules | modules | modules | modules | modules | modules |
| cells | used in | used in | used in | used in | used in | used in | used in | used in |
| in series | group 1 | group 2 | group 3 | group 4 | group 1 | group 2 | group 3 | group 4 |
| | Alternative 1 | | | | Alternative 2 | | | |
| 215 | 12 | 3 | 1 | 3 | 13 | 2 | 0 | 2 |
| | Alternative 3 | | | | Alternative 4 | | | |
| 215 | 14 | 0 | 1 | 0 | 12 | 2 | 3 | 2 |

Assume that Alternative 1 is used at a certain time. Assuming that there is a load current (60) passing the Circuit Arrangement, which is sampled by the control unit (20). It is now possible to perform active cell module balancing between the cell modules in group one and in group three, as there are three cell modules out of thirteen bypassed in group 1 and two out of three cell modules bypassed in group three. The control unit (20) will successively integrate the charge passing each cell module and add that to the value given by the SOC estimator and will also evaluate how close the SOC value of each cell module within these two groups are to the respective SOC target value.

The control unit will identify which of the ten cell modules within the group 1 which has highest SOC value as compared to the target value and which of the three bypassed cell modules that has the lowest SOC value as compared to the target value and also determine if the error is large enough or larger than a threshold value for at least one of the cell modules to perform a state change. The transistor pairs of these two cell modules that has been identified by this method will be prepared for state change and if the time is right the state change will happen synchronized with a trigger pulse, to make the state change to happen at the same time in both transistor pairs. The reason for synchronizing the switching events is to minimize the voltage change or voltage disturbance that will happen on the DC link voltage due to this change in state. All voltage disturbance will also create a current pulse passing the battery cells, which will create both additional losses and some electromagnetic disturbance due to the change of voltage and current.

Now, what do we mean with “if time is right”? This may for example be decided by that the error in actual SOC values as compared to the target SOC is large enough and that a minimum time has elapsed since last active cell balancing event and that enough time has elapsed since last change in transistor pair state due to the need of voltage control. If the load current or charging current is high, the time between these active cell balancing events may be shorter, as the error to the target SOC value will increase faster. It is here anticipated that the time between active cell module balancing switching events within each group of cell modules will be larger than 100 ms and smaller than 100 s, at least during all normal operating conditions. In case of very small charging current or loading current, normally no switching events needs to take place as there is no charge to balance.

The same type of balancing algorithm can be done between the cell modules within group 3.

Assume now that the number of total series connected cells will be 185 for some time. The control unit (20) will also evaluate the SOC value in the cell modules of group 2 and group 4. as all cell modules are used in these groups, the error of the SOC value from the target value will not change much within each group.

However, also the target SOC value will change over time as there is a load current passing the Circuit Arrangement. Assume that the cell modules of group 2 and group 4 was close to the target value at a certain time. As the cell modules in Group 2 and in Group 4 are used more than the average cell modules in the total circuit arrangement, the error to the target SOC value will increase. This is also true for the error of the SOC value for the modules within group 3, as this group is not used as much as the average cell module. Here it is a need for balancing SOC between groups of cell modules.

This can be done by shifting from alternative 1 to alternative 4. In alternative 4, less charge in average is passing the cell modules of group 2 and 4 as compared to the average charge passing the cell modules in group 3. With average charge we mean the charge times, i.e. multiplied by, the percentage of cell modules connected to the series connection at a certain time interval. This is the opposite to the situation as in alternative 1. This makes it possible to do active cell module charge balancing between group 2/4 and group 3.

In some cases, there will only be one or two alternatives to choose from for a certain number of series connected cells. Normally, voltage control will have priority and charge balancing can be done according to what is possible to achieve.

In certain situations, however, charge balancing can have priority over voltage control. Such a case can for example be when maximising the energy of a battery or a circuit arrangement according to the invention while charging. Here it can be beneficial to instead make best possible active cell balancing between all cell modules and group of cell modules, as the voltage during charging often can be a parameter which has more freedom, in case a vehicle is charged from a charging station.

As already mentioned above, active cell balancing may be performed with the embodiments herein. Depending on context, active cell balancing may refer to balancing between cell modules within a group. This is herein sometimes referred to as “active cell module balancing”.

In embodiments with active cell module balancing, the control unit 20 is configured to: perform active cell module balancing among cell modules of the first group by alternatingly switching between a first group configuration and a second group configuration. The first group configuration and the second group configuration include a same number of cell modules that contributes to the voltage target.

In more detail, it may be that at least one cell module of the first group configuration is excluded from the second group configuration. Typically, the same number of cell modules is less than the first number of cell modules.

In these examples, it may be that the control unit comprise a respective sub-control unit for each group among the first and said at least one second group, to control charging level of each cell modules within said each group to be within a range and within a safe operating range for each cell module. As an example, the respective sub-control unit may be configured to alternate those cell modules that contribute to the output voltage to maintain a similar state of charge within said each group.

In other contexts, active cell balancing may refer to balancing between groups. This is herein sometimes referred to as “active group balancing”. In embodiments with active group balancing, the control unit 20 is configured to: perform active group balancing among the first group and the second group by alternatingly switching between a first circuit configuration and a second circuit configuration.

When active group balancing is performed, it may be performed while maintaining a same number of battery cells that contributes to the output voltage, or while allowing for a slightly different number of battery cells to contribute to the output voltage, e.g up to 5 cells, preferably up to 4 cells, most preferably up to 3 cells or even up to only 1 cell. With reference to the tables above, this translates to switching between alternatives, or circuit configurations, on the same row and to switching between alternatives on neighbouring rows, or almost neighbouring rows, respectively.

In examples with the same number of battery cells, e.g the same voltage, the first circuit configuration and the second circuit configuration include the same number of battery cells that contributes to the voltage target. In this or other examples, it may be that at least one cell module of the first group of the first circuit configuration is excluded from the second circuit configuration and at least one cell module of the second group of the second circuit configuration is excluded from the first circuit configuration. Typically, a total number of cells of said at least one cell module of the first group matches a total number of cells of said at least one cell module of the second group. In examples with the slightly different number of battery cells, e.g almost the same voltage, a difference in battery cells, that contributes to the voltage target, between the first circuit configuration and the second circuit configuration corresponds to a difference in number of battery cells between cell modules of the first group and cell modules of the second group. In this example, or other examples, at least one cell module of the first group of the first circuit configuration is excluded from the second circuit configuration and at least one cell module of the second group of the second circuit configuration is excluded from the first circuit configuration. Typically, a total number of cells of said at least one cell module of the first group differs from a total number of cells of said at least one cell module of the second group by the aforementioned difference in battery cells.

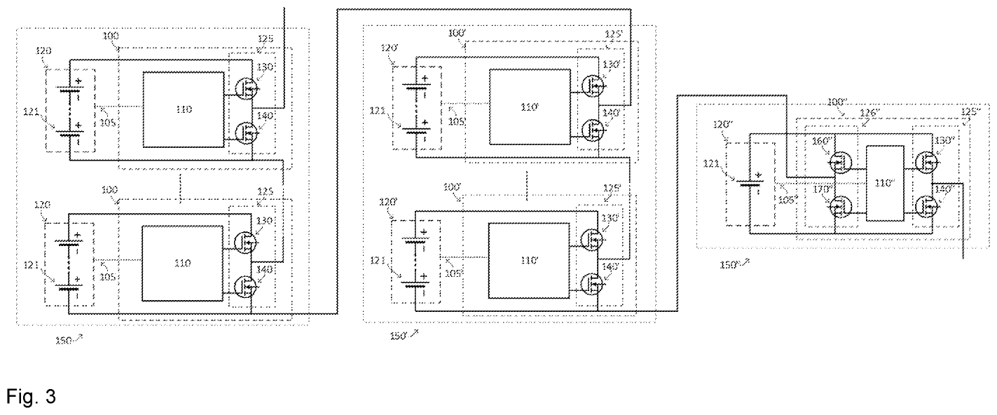

FIG. 3 shows another exemplifying circuit arrangement including three groups of cell modules, 150, 150′ and 150″. In this example, the cell modules 120, 120′ comprise:

a third group of cell modules 150″ comprising a third number of cell modules 150″. Each cell module 120, 120′, 120″ of the third group has a third nominal cell module voltage that is less than the second nominal cell module voltage. A respective contributing number of cell modules 120, 120′, 120″ of the third group is controllable by a respective electronic module 100″ for each cell module 120″ of the third group,

The third group has less nominal voltage than the two first groups. This gives an opportunity for even better voltage resolution. In this example the third group only includes one cell module 120″ with only one cell in series, 121. In this example the circuit module 100″ includes two transistor pairs, 125″ and 126 “, connected in a full bridge configuration, which give the possibility for adding both a negative voltage, a positive voltage or no voltage by bypassing the cell module.

The third group can however also include two or more cell modules, there each cell module can have one or more than one cell in series and it can use a half-bridge switch circuit instead of a full bridge switch circuit.

Moreover, similarly to the previous examples, the control unit 20 is configured to control at least one respective electronic module 100, 100′, 100” for one or more of the first, second and third groups to adjust the respective contributing number of cell modules 120, 120′ of at least one of the first, second and third groups. Each cell module 120, 120′ of the respective contributing number of cell modules 120, 120′ is contributing, positively or negatively, to the output voltage of the circuit arrangement 10.

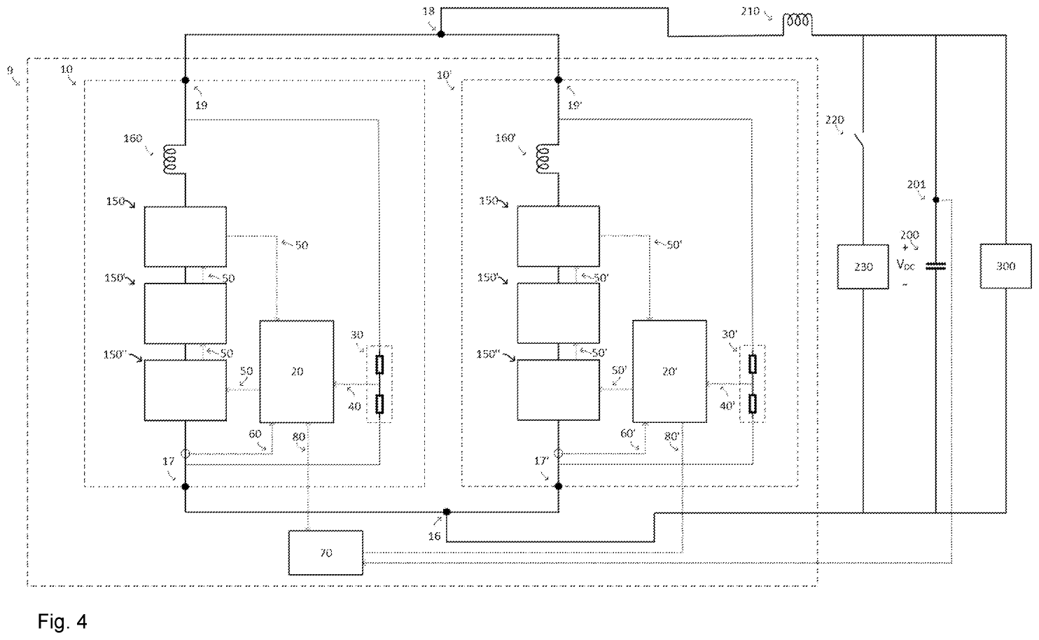

FIG. 4 shows an example in which two or more circuit arrangements 10, 10′, e.g. of the kind shown in FIG. 1 or FIG. 3, are included together with a battery arrangement controller 70 to form a battery arrangement 9. The battery arrangement 9 is configured to control the voltage V_{DC}, i.e. the output voltage of the battery arrangement 9, across the DC link capacitor 200, as measured by a voltage sensor 201 and the current distribution between the individual circuit arrangements 10, 10′, as measured by the current sensor signals 60, 60′, when connected to a power unit 230, 300, which is either feeding or draining power to/from the battery arrangement 9. The circuit arrangements 10, 10′ are connected in parallel to the same DC link bus 18, 16 in the connection point 18 which is the plus pole of the DC link bus and in the connection point 16, which is the minus pole of the DC link bus. In this case an inductor 210 is also placed in series with the DC link capacitor 200 and the connection points 18, 16 of the battery arrangement 9, to indicate that the battery arrangement can be placed at some distance from the DC link capacitor and the power unit 230, 300. The cables connecting these units will in practice have some inductance and some resistance as well, so the measured voltage across the DC link capacitor V_{DC} by the voltage sensor 201 can be slightly different as compared to the voltage measured by the voltage divider 30, 30′ of each circuit arrangement 10, 10′.

As mentioned, the battery arrangement 9 comprises the first circuit arrangement 10 and said at least one second circuit arrangement 10′. The first circuit arrangement 10 and said at least one second circuit arrangement 10′ are parallelly connected to a pair of terminals 16, 18 for connection to the power unit 230, 300. Furthermore, the battery arrangement 9 comprises the battery arrangement controller 70. The battery arrangement controller 70 may for example be external to said two circuit arrangement 10, 10′ but could also be included in one of the circuit arrangements, 10, 10′, which in this case would serve as a master among the parallelly connected, or connectable, circuit arrangements 10, 10′.

Each control unit 20, 20′ can adjust the number of series connected cell modules to control the output voltage between the respective poles, 19 and 17 resp. 19′ and 17′. This gives a possibility for the external control unit 70 not only to control the voltage of the DC-link bus but also the control the current delivered to or from each circuit arrangement 10, 10′, which is called the current distribution.

There are many possible ways for the external control unit 70 to control both the current and voltage from the circuit arrangements 10, 10′. If the controller delivers a target set voltage value to both circuit arrangements, there is risk for instability, especially if one of the circuit arrangements has an error in the voltage measurement. One preferred way with reduced risk for instability is described below.

The battery arrangement controller 70 receives information of the measured voltage 40, 40′ and the measured current 60, 60′ from each of the circuit arrangement controllers 20, 20′. The battery arrangement 70 controller also receives information about which cell modules of the first and said at least one second circuit arrangement 10, 10′ that are included in the series connection and in case the cell module is controlled by a full bridge, also the direction of the voltage. In case a half bridge is used, the contributed voltage cannot be switched between different directions. Furthermore, the battery arrangement controller 70 receives information of the measured voltage of each cell module, also for the cell modules that are bypassed. The battery arrangement also receives information about the cell status, including voltage and temperature information, in each cell module of the battery arrangement, which can be on a very detailed level for each cell or summarized in a number of parameters for each cell module. This is done in such a way that the battery arrangement controller or an external controller (being external to the battery arrangement) can draw conclusions of how to distribute the current between the circuit arrangements 10, 10′, to for example minimize losses, maximise lifetime of the cells or to balance State of Charge between the circuit arrangements 10, 10′. In vehicles with several parallel batteries or circuit arrangements, such an external controller can be called an ESS controller. It is in the following assumed that the Battery arrangement controller 70 receives information about the target set voltage for the DC link and how the current or power shall be distributed between the circuit arrangements in average from an external control unit, such as an ESS controller, but as already mentioned, this can vary from application to application.

The battery arrangement controller 70 will now try to minimize the error between the requested DC link voltage and measured DC link voltage, as measured by the voltage sensor 201. The battery arrangement controller 70 will also minimize the error between the requested current distribution (or power distribution) and the measured current distribution for a certain time period, as delivered to the controller from the circuit arrangement controllers 20, 20′. The target current distribution or power distribution can for example be given in percentage of the total current or power delivered to or from the battery arrangement. As an example, in case there are two parallelly connected circuit arrangements 10, 10′, the target current distribution may indicate 55% and 45%, which adds up to 100%, of a total current to/from the DC link capacitor 200. Another example may be −20% and 120%, as it sometimes can be preferred to have one circuit arrangement to charge another while delivering or receiving a certain current to a power unit. Clearly, since the target current distribution always has to add up to 100%, it is sufficient that a respective target current distribution for all parallelly connected circuit arrangements 10, 10′ but one is provided, e.g by the battery arrangement control unit 70. Alternatively or additionally, the target current distribution may be indicated by a respective absolute value for the current to/from the respective circuit arrangement 10, 10′, such as 4 A, 2 A and −6 A for a case when exchanging no power with the power unit 230, 300.

To support this control, the controller 70 often has a circuit model of both the battery arrangement and the connection of the battery arrangement to the DC link. This model can either be a simple circuit model such as source voltage, internal resistance and internal inductance of each circuit arrangement and resistance and inductance of the common connection between the battery arrangement and the DC link bus, including also a DC link capacitor 200. The circuit model can also be more advanced including a more detailed model of each cell module inside the circuit arrangements 10, 10′. The controller 70 is equipped with means for identifying these circuit parameters and adapt these circuit parameters over time. For example, the resistances are often strongly temperature dependent, especially inside the battery cells and they can also vary with current direction. As the cell modules inside the circuit arrangements either is connected or bypassed from the series-connection, it is rather straightforward for the controller 70 to update the parameter internal resistance, per cell module by sampling the cell module voltage at different currents and at different current directions. If also the current 60, 60′ is sampled at enough high frequency, it is possible to estimate the internal inductances 160, 160′ and 210, by evaluating the current, the current derivatives and the information given by the different voltage sensors, 40, 40′ and 201. In order to estimate the inductance 201, a change in current from the power unit 230, 300 is needed. As an alternative, instead of a circuit (white box) model, a suitable black box model with sufficient degrees of freedom to capture the dynamics may be applied, possibly in combination with recursive parameter estimation, well known from literature.

An example will now be given to explain how the controller may control the current distribution or power distribution between the circuit arrangements. When the controller detects that the error between the target current distribution and the measured current distribution is higher than a certain value such as a threshold value, at least for one circuit arrangement, it will detect which of the circuit arrangements that has largest positive deviation to the target value and which one of the circuit arrangements that has the largest negative deviation. The threshold value can be an integral of the current deviation as a function of time or a combination of the current deviation and the integral of the current deviation. The controller has now two possibilities to reduce this error. One possibility is to increase the number of series connected cells in one of the circuit configurations or to reduce the number of series connected cells in the other circuit configuration. To decide which is best, the error in the DC link voltage as measured by the voltage sensor 201 and the target DC link voltage will be evaluated. In case of that the total current as measured by the current sensors 60, 60′ is either increasing or decreasing, this evaluation can also include to take into account how large part of the voltage measured by the voltage sensor 201, is across the inductances 210, 160 and 160′. The controller 70, will now send a control signal to request a change in the number of series connected cells, to one of the circuit arrangements 10, 10′ that minimizes the error to both the requested current distribution and to the requested DC link voltage 201. In many cases, this control method will be enough to control both the current or power distribution between the circuit configurations and to control the DC link voltage at the same time.

Now it will be explained how the DC link voltage can be controlled without changing the current distribution between the circuit arrangements, 10, 10′. This method is often used during e.g. larger changes in load or charging current. The controller will in this case detect that the error between the requested DC link voltage and the measured DC link voltage by the sensor 201 is increasing. If the error is increasing beyond a threshold value, the controller will send a request to change the number of series connected cells to each of the parallel connected circuit arrangements 10, 10′ at the same time, to reduce the error. Also in this case, the dynamic performance of this regulator can be improved by knowing of how much of the voltage error is due to voltage across the inductors 210, 160, 160′. Due to internal differences between the circuit arrangements 10, 10′, it is possible that the change in number of series connected cells in the circuit arrangements 10, 10′, can create a step voltage change between the poles 19, 17 resp. between 19′, 17′ which is not completely equal. In this case a slight shift in current distribution can happen, but in this case the current distribution regulator will be activated when this error is large enough (normally it will primarily act on integral errors of current described earlier and on a longer timescale.

Clearly, as seen from the examples above, there are many ways in which the output voltage and the current (power) distribution can be controlled. It is well known from the literature that such controllers may be straight forward PID-controllers or the like, or more sophisticated control strategies based on models of the system to be controlled. Since the physical system (batteries) under consideration change their properties over time and during operation, the models are time varying, which suggests that a recursive model parameter estimation may be beneficial, in which case we have an adaptive control system. The control strategy may apply feedforward and feedback. Feed forward may be advantageous to use in the application considered here, since a change in cell module configuration is known to the system controller (70) before (a priori) it is executed. A feed forward control loop which uses said models can be beneficial to reduce the impact of the a priori known shift. A model predictive control (MPC) may be applied, in which case the model is used to predict the output of the system in a specified horizon ahead, and hereby find the control signal (which combination of battery modules that shall be connected in series) that minimizes the loss function. The control strategy may be designed to minimize the value of the control criterion function (loss function) by minimization using only one control parameter at a time, or a subset of the available control parameters, or by simultaneously use all available control parameters. An optimal controller would use all available control parameters simultaneously, but that may become computationally expensive and therefore not practical. Note also that different criterion functions may be used, punishing different aspects of the system performance (voltage, current, power, or combinations thereof), and that different criterion functions may be used in different states of the circuit arrangement and/or the ESS.

The dynamics of the states of charge and health etc. is a much slower process than the dynamics associated with the currents and voltage of the parallel circuit arrangements. In some architectures it is beneficial to separate the “fast” control of such circuit arrangements and the control of the State of Charge (SoC) and State of Health (SoH) etc. Then a “fast control loop” may control the voltage and currents of a battery configuration, while a “slow control loop” may control the states, I.e., the SoC and SoH, and in short, the state of everything, SoX.

Below it will be described some reasons to change the DC link voltage set point and to redistribute the current or power between the circuit arrangements. The target set voltage is normally not changing much as a function of time but can for example be different during loading or driving a vehicle as compared when charging a vehicle at a charging station, there a higher voltage may be used. Normally a set voltage is used that is at a suitable distance from a maximum allowed DC link voltage. A high DC link voltage, normally minimize the losses in the total energy system such as the battery arrangement 9 and the power unit, 300 (e.g. inverter+motor), In other applications, such as connecting the battery assembly for receiving power from for example solar photovoltaic (PV) installation or a fuel cell, the target set voltage can change over time to maximise the efficiency of the solar PV installation or the fuel cell.

The goal is to balance the current distribution between the circuit arrangements such that the circuit arrangements, 10, 10′ are utilized optimally to for example minimize the losses in the battery arrangement or maximise the mileage until next possible charging opportunity or maximising the lifetime of the battery cells included in the circuit arrangements. During load changes, the current distribution can change and circulating current between circuit arrangements 10, 10′ can occur. This happens normally on all normal, not voltage-controlled, parallel connected battery packs. Here, the control unit can adjust the configuration of the circuit arrangements, to achieve an optimal current distribution to avoid circulating currents between the circuit arrangements. The target set current or target current distribution can be based on the State of Charge, State of Power (the power the circuit arrangement can deliver for the moment), temperature of each of the circuit arrangements 10, 10′, temperature of individual cells or cell modules and to minimize circulating current between parallel connected circuit arrangements.

During both a normal and fast charging event, the current distribution is also controlled to achieve similar properties. This can for example be to control that the battery cells in each circuit arrangement 10, 10′ is charged at an optimal rate, to reduce the charging time, to avoid overheating of any battery cells, to reduce the charging current in case the battery cells are at a high state of charge, to distribute the current in an optimal way in order to minimize the losses in the battery arrangement or to minimize the ageing of the battery cells in the circuit arrangements etc.

This means that the external control unit 70 is further configured to control a respective current or a respective power for each of said at least one second circuit arrangement 10′ towards a respective current target, e.g. the target set current, for each of said at least one second circuit arrangement 10′ based on a respective difference between the respective current target and a measured respective current 60′. The respective current target is successively updated to balance current distribution between each one of the first and said at least one second circuit arrangements 10, 10′.

There is also at least one special case that may be considered. In this special case example, the controller 70 may ensure that the voltage of the DC link bus between the positive pole 18 and 16 is not increased beyond the maximum allowed value, as this can for example destroy the power unit 300. One such situation is if the power unit 300 is loading the DC bus at high current and the load suddenly disappears or even that the power unit 300 reverses power from a load situation to a charging situation. For this purpose, the controller 70, is sensing the DC-link voltage across the DC-link capacitor 200, with support of a voltage sensor 201 sensing the voltage across the DC link capacitor 200. This helps the controller 70 to quickly recognize this situation and sense if the voltage of the DC link capacitor starts to rise quickly. Alternatively, another controller, such as a vehicle controller not shown in FIG. 4, controlling the delivered power to or from the power unit 300, can inform the controller 70 that there is or will be a fast change in load situation. The same information that the vehicle controller sends to the power unit 300 commanding this change can also be sent to the controller 70 for information. In this case, the controller 70 can rapidly command a number of changes in number of series connected cells to all of the circuit arrangements 10, 10′. In this way, the controller 70 can command the controllers 20, 20′ for making a coordinated change of the number of series connected cells to avoid that the DC link capacitor voltage will be higher than the allowed maximum value.

In view of the above and again with reference to FIG. 4, the embodiment(s) of FIG. 4 is described again, although some repetition may occur.

The battery arrangement 9 is configured to control output voltage V_{DC} towards to a DC link voltage target on a DC link, i.e over the DC link capacitor 200, The DC link and/or the DC link capacitor 200 is connectable to the power unit 230, 300. The battery arrangement 9 comprises cell modules 120, 120′ included in:
a first circuit arrangement 10, comprised in the battery arrangement 9, and at least one second circuit arrangement 10′, comprised in the battery arrangement 9. The first circuit arrangement 10 and said at least one second circuit arrangement 10′ are parallelly connected to the pair of terminals 16, 18 for connection to the power unit 230, 300.

The battery arrangement 9 comprises a battery arrangement control unit 70 configured to receive, e.g. from the respective control unit 20, 20′, information comprising, i.e. information about or relating to:
a respective measured current for each one of the first and said at least one second circuit arrangement 10, 10′,
a measured voltage on the DC link, such as measured over the DC link capacitor, each of the first and said at least one second circuit arrangement or the like.
a respective circuit configuration relating to which of the cell modules that contribute to voltage over each of the first and said at least one second circuit arrangement.

Moreover, the battery arrangement control unit 70 is configured to receive, e.g from a primary control unit e.g. an ESS of for example a vehicle, information comprising, i.e information about or relating to:
a target current distribution indicating a respective target current for each of the first and said at least one second circuit arrangement 10, 10′, and
the DC link voltage target.

Furthermore, the battery arrangement control unit 70 is configured to control the output voltage towards the DC link voltage target by assigning changed circuit configurations based on the respective measured current for each one of the first and said at least one second circuit arrangement 10, 10′, the measured voltage on the DC link, and the respective circuit configuration, while reducing, such as minimizing, a loss function defining a measure of the deviation from the target current distribution. Accordingly, the battery arrangement control unit is configured to perform a control of the output voltage.

In order to more accurately control the output voltage, the battery arrangement control unit 70 may be configured to:
apply a model over the battery arrangement 9, wherein the model has model parameters describing dynamic properties of the battery arrangement 9, and
estimate the model parameters based on one or more of:
   the respective measured current for each one of the first and said at least one second circuit arrangement 10, 10′,
   the measured voltage on the DC link, and the like.

As an example, the dynamic properties, or physical properties, of the battery arrangement 9 may comprise one or more of voltage sources, internal resistance, capacitance, inductance or the like for each of the circuit arrangements of the battery arrangement 9. The properties may be dynamic because they are not constant, e.g. the properties change over time For example can a battery cell or cell module inside the circuit arrangement be modelled by a voltage source in series with one resistance and one inductor in series with one or several of parallel connected resistances and capacitors. Some electrical properties may vary depending on various factors, such as time, power exchanged with the battery arrangement, temperature, direction of current or the like. It may therefore be advantageous to adaptively estimate the electrical properties based on the measurements listed above.

Further, the battery arrangement control unit 70 may be configured to perform the control of the output voltage by use of the model. Thus, a more accurate control of the output voltage may be achieved.

In some examples, the measure voltage on the DC link may be given by a respective voltage over each one of the first and said at least one second circuit arrangement that is sent from the control units 20, 20 to the battery arrangement controller 70.

In further examples of the battery arrangement 9 of FIG. 4, the battery arrangement control unit 70 may be configured to:

apply a further model over the battery arrangement 9, wherein the further model has model parameters describing states of the battery arrangement 9, and
estimate the model parameters based on one or more of:
   SoC,
   SoH,
   SoP (State of Power),
   SoT (State of Temperature) and
   the like.

In these examples, the battery arrangement control unit 70 may further be configured to perform the control of the output voltage by use of the further model. The further model is typically different from the model, i.e. not the same as the model. In this manner, expected lifetime of the battery arrangement may be improved.

We can here summarize the advantages with using a basic model and also a further model inside the controller 70 to support the control of the battery arrangement. First of all such a model can improve both the capability for the controller to keep the DC link voltage close to the target value and at the same time to keep the current distribution error, or if integrated over time the charge distribution error, small, at least as measured over a certain time period. A good model will support the controller to keep the error of these two parameters small also during transient conditions such as during fast changes in total power exchanged with a power unit. Often, it is most important to have a good voltage control during such transient conditions, but it is also of interest not to have to large errors in the current distribution, as this can cause additional losses or additional temperature ripple in the circuit arrangements.

If such a further model also covers each cell module, the model can help to improve active cell balancing in terms of SoC, both within each group and between groups, which means that the capacity as measured in Ah or total energy of the total battery arrangement improves. Proper modelling on the cell module level can also limit the temperature ripple in the battery cells, by changing the configuration of the cell modules at a proper rate, without choosing such a high rate that switching losses in the transistors will increase such that these will limit the efficiency of the battery arrangement. A low temperature ripple in the battery cells is improving the lifetime of the cells.

By also monitoring for example the cell module voltage for both connected and disconnected cells and how this voltage varies with time, for connected cell modules in both current directions, the model will be able to predict more accurately what will happen during a change in configuration or during a change in current. This type of predictions makes it possible for the controller to minimise voltage ripple and errors in current distribution, not only by choosing the best possible new configuration but also the correct timing for next change to take place.

A further model can also improve the power that can be drawn from the battery arrangement, by keeping track of how much power each cell module can deliver at each time. This makes it possible for the controller 70 to configure the battery arrangement properly at high power conditions. For example, one of the circuit arrangements might have battery cells with very good power capability, with low internal resistance. When the load is high, an ESS controller can command the controller 70 to deliver a current distribution from the battery arrangement, there a large part of the power shall be drawn from the circuit arrangement with highest power capability. By knowing which cell modules that have best power capability and a proper State of Charge without any severe ageing problems such as high resistance or may be high temperature due to less good cooling etc, the controller 70 can configure the battery arrangement to support this high power command in best possible way, based on the detailed knowledge of each cell module. Such a model can also be further improved down to cell level, there for example the variation of the cells inside a module can be describe with a number of parameters, such as variation of different variables such as temperature, SoC, source voltage, internal resistance etc and especially if there is any cell that is limiting the performance of the cell module in one or more of these parameters. Further, safety of the battery arrangement may be improved, e.g. due to less risk of damage thanks to that temperature is taken into consideration in the control of the configuration, there some configurations may be more optimal during for example low power conditions and other configurations may be more optimal during high power situations.

To describe a preferred control system architecture, consider a battery arrangement comprising a plurality of circuit arrangements 10, 10′, controlled by a primary control unit 70, which in turn controls several circuit arrangement controllers 20, 20′, that either includes or bypasses cell modules 150, 150′, c.f., FIG. 4. In the following, a mathematical framework to describe such a control system is given. The example given here serves as an example to clarify the involved control loops and how a model of the battery arrangement and its components may be used to optimize, or at least improve, the performance. For simplicity, consider the case of m circuit arrangements assumed to have the same number of cell modules, n.

Let d̅ᵢ(t) denote a control vector that describes the configuration of the cell modules in the l: th circuit arrangement out of the m circuit arrangements connected in parallel, i.e., d̅ᵢ(t) determines which cells that are included in the series connected cell modules, and which that are bypassed. Then d̅ᵢ(t) is of dimension (n|1), where n is the number of cell modules, i.e., d̅ᵢ(t)=(d₁₁(t), d₁₂ (t), . . . , dᵢₙ(t))^{T} with entries either equal to one or zero (I/O), depending on if the cell module is included or bypassed, respectively. In a similar manner, let v̅(t) denote a vector of cell module voltages; v; (t)=(vₗ₁ (t), v₁ₗ(t), . . . , vₗₙ(t))^{T}. The voltages depend on which group of cell modules the cell module is of, and several time dependent variables such as the current through the cell module, the temperature, the state of charge (SoC), the state of health (SoH) and other variables that affect the behavior of the cell module. The voltage over a circuit arrangement can then be written as Vₗ(d̅(t); t)=d̅^{T}(t)·v̅ₗ(t). Let
Vₘₑₐₛ(t) [symbol] measured load capacitor (20) voltage
V_{ref}(t)≙ reference load capacitor voltage

V̅(t)≙V_{ref}(t)−Vₘₑₐₛ(t)
iₗ(t) A measured current through circuit arrangement l, l=1, . . . , m
i_{ref,i}(t) A reference current for circuit arrangement l, l=1, . . . , m
lᵢ(t)≙i_{ref,l}(t)−iₗ(t), the circuit arrangement current error, l=1, . . . , m

\tilde{l}(t)ϑ(i₁(t),i₂(t), . . . ,ĩₘ(t))^{T}
D(t)≙(d̅₁(t),d̅₂(t), . . . d̅ₘ(t), a (n|m) matrix of cell module configurations

Note that D(t) is the control variable with which the system is controlled. A quadratic control criterion (loss) function may be written as

$$G ( D ( t ) ) = α {( \tilde{V} ( t ) )}^{2} + {\vec{β}}^{T} \cdot \tilde{I} ( t ) \cdot \vec{β}$$

where α and β are weighting factors greater than zero that weigh how much the load capacitor voltage error (t) and the circuit arrangement current errors Ĩ(t) affect the criterion function, i.e., through α and β the general behaviour of the controlled system can be affected. The currents through the circuit arrangement I depend on the cell module configuration (the control signal) d̅ᵢ(t) and the cell module voltages v̅ᵢ(t), i.e.,

iₗ(t)=ƒᵢ(d̅ᵢ(t),θ̅ₗ)

where fi (.) is a function that describes how the current it (t) depends on the configuration dᵢ(t) (the control signal) and some other physical parameters θ̅ₗ, where θ̅ₗ denotes a vector of such function description parameters. For example, if the circuit arrangement (hypothetically) behaves like a resistor, then the value of that resistor would constitute the function description and θ̅ᵢ=Rₗ, where Rₗ is the value of the resistor. The resistance may be affected by the temperature and how much current that has flown through the battery, and the age. Clearly, θ̅ₗ may be time dependent and preferably estimated (computed) from measurements.

By minimizing the criterion (loss) function G(D(t)) w.r.t. the control signal (configurations) D(t), the voltage over the load capacitor may be kept close to the reference value, while keeping the currents through the circuit arrangements close to their reference values.

As an alternative to absolute values of the reference current, relative measures may be used, e.g., by normalizing the currents with the total current from the battery arrangement. Such an approach is applicable provided that the total current is not zero, which may be the case if no current is flowing out of the battery assembly, but only flowing between the circuit arrangements. Then the current reference values need to be computed using some other strategy and given as absolute values.

The control objective may be achieved by using feed-back from V̅(t) and Ī(t), or by using feed-back in combination with feed-forward. Feed forward in the control loop may be a preferred solution, since a change in the control variable (configuration) D(t) is known by the primary controller 70 and the circuit arrangement controller 20 a priori, and hence actions may be applied to smooth a change by instead applying several changes. There are many approaches to which the criterion function may be minimized and the one best suited for the purpose depends on the application and trade-off's such as cost and computational burden.

If the dynamics of the circuit arrangements were known, i.e., θ̅ₗ, l=1, . . . , m were known, then the performance of the controller could be further improved, or even made optimal, by taking these dynamics into account. Unfortunately, the function description vectors θ̅ₗ is usually not known. Then a model of or may be used to improve the performance of the controller, and the parameters of the model estimated from measured data such as voltages and currents. Let such a model be denoted by \hat{θ}(t). An example of such a model may be an equivalent circuit model, or a black box model with sufficient degrees of freedom to capture the dominating dynamics of the circuit arrangement. Such a model may be used in a model-based control strategy. Such strategies are well known to the engineers skilled in the art and the literature is rich of descriptions and analysis of numerous approaches to identify such model structures and estimate the model parameters from measurements. Simple approaches may be practical and cost efficient, e.g., by modelling the circuit arrangement by an equivalent circuit of low complexity and then estimate the parameter values from the measured data. Even though such a model may not correctly describe the circuit arrangement dynamics, it may greatly improve the control if it captures a dominating dynamic. One model-based control approach of interest may be to apply a model predictive control (MPC) strategy, motivated by that the configuration change is known a priori.

Now, consider the SoX, i.e., the SoC and SoH. Note that the states of a rechargeable battery normally changes significantly slower than the voltage and current. It is an objective of the invention to control the voltage and currents such that the SoX is optimized over time and hereby significantly reduce the cost of battery assemblies. This is achieved by controlling the current distribution i (t) through the circuit arrangements over time. Consider the following loss function:

$$H ( D ( t ) ) = {\vec{γ}}^{T} \cdot ( t ) \cdot \vec{γ} + {\vec{ϑ}}^{T} \cdot ( t ) \cdot \vec{ϑ}$$

where γ̅ and θ̅ are weighting vectors of dimension (n|1), and

$$( t ) = ( \begin{matrix}{1 , 1}_{} ( t ) & … & {1 , m}_{} ( t ) \\ ⋮ & ⋱ & ⋮ \\ {n , 1}_{} ( t ) & … & {n , m}_{} ( t )\end{matrix} )$$

describes the deviation of the state of everything (SoX, e.g., SoC and SoH) from desired states, with the state deviations of the n cell modules of the l: th circuit arrangement in the l: th column of [symbol] (t).

It is well known to the skilled engineer that [symbol] (t) is affected by currents, voltages, age and temperatures and may be estimated from measurements of the currents, voltages, and temperatures. By estimating S̅o̅X̅(t) from such measurements and compare with known preferred states, the deviation [symbol] (t) may be estimated, and control actions through D(t) may be taken, such that the criterion (loss) function H(D(t)) is minimized. Hereby the lifetime of the battery cells can be significantly increased with a substantial cost saving as result. Also, the range of the battery assembly may be significantly increased by such a control.

Since the dynamics of S̅o̅X̅(t) is significantly slower than that of V(t) and I(t), it is preferred to implement this as an outer (slow) control loop controlling SoX(t), and an inner (fast) control loop controlling Vₘₑₐₛ (t) and the circuit arrangement currents it (t), l=1, . . . , m. Then, the outer control loop (minimizing the criterion function H(D(t))) may set reference target values for the average currents through the circuit arrangements over a certain time horizon ahead, say within τ ∈ [t, t+T], based on previous measurements of currents, voltages, and temperatures. Then the controller minimizing G(D(t)) may select D(t) subject to this constraint such that H(D(t))) is minimized “on the average”, while securing stability for the battery arrangement during operation.

There may, of course, be other ways to mathematically describe such a control system. The important aspects are, however, that the control is preferably model based, and consists of an outer (slow) loop minimizing [symbol] (t), and an inner (fast) loop, minimizing V(t) and I(t). The control may use feed-back and feed-forward. The control parameter is the cell module configurations, D(t), used to minimize a criterion (loss) function designed to minimize specific application dependent objectives.

The assumption that the m circuit arrangements have the same number of cell modules, n, can easily be generalized to the general case, but such a generalization is not included here.

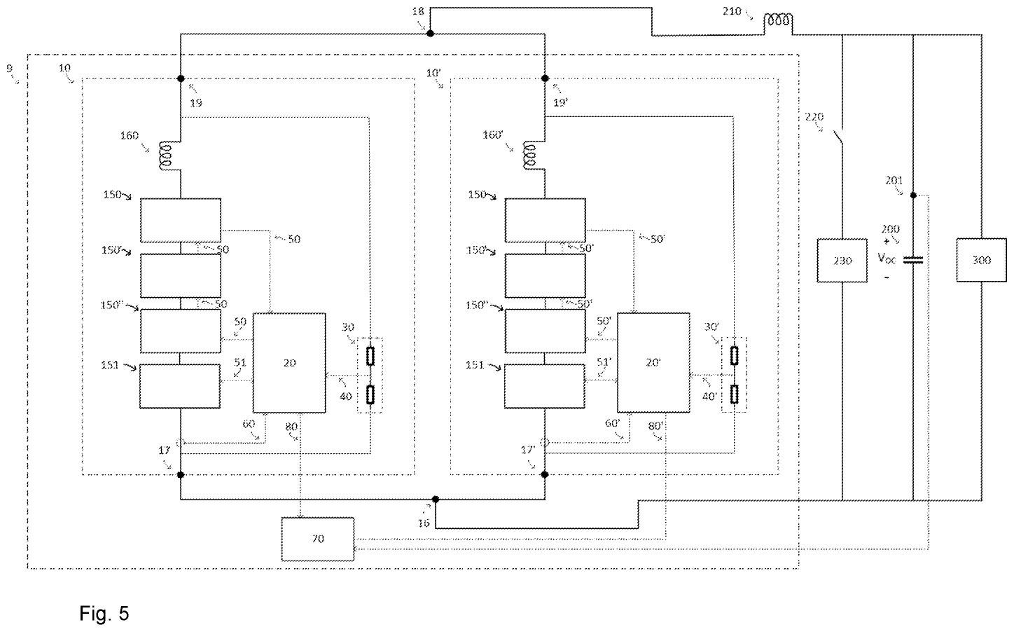

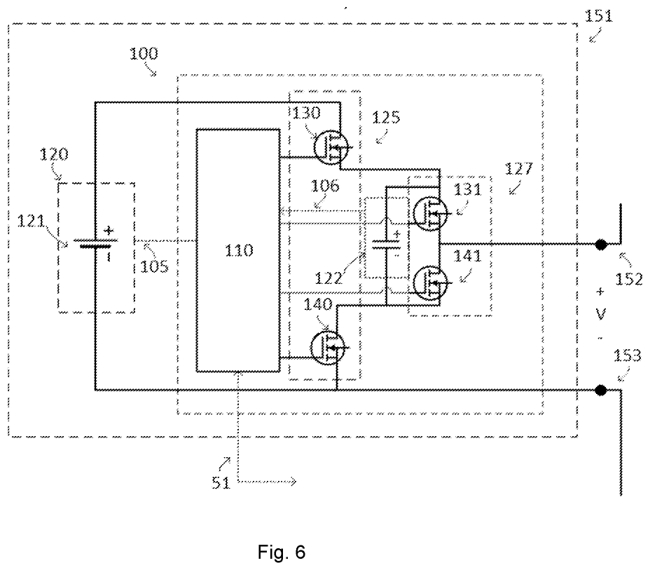

FIG. 5 is a variation of FIG. 4, in which an additional set of cell modules 151 is added to the series connection of the existing group of cell modules 150, 150′, 150″. The additional set of cell modules 151 may in case there are more than one cell module 120 in the set of cell module 151 be referred to as “an additional group of cell modules 151”, thereby conforming to the terminology used herein. Nevertheless, the term “additional set of cell modules 151” is used to indicated that there may be only one cell module in the set. The additional set of cell modules 151 is controlled by the control unit 20, 20′ via a control line 51, 51′. A previously mentioned, each cell module may comprise one or more cells. Typically, the cell module of the additional set of cell modules 151 comprises one cell, aka one battery cell. This means that the additional set of cell modules 151 is slightly different from the (other) groups of cell modules 150, 150′, 150″. Details of the additional set of cell modules 151 are presented in FIG. 6. The number of different groups of cell modules, is not restricted to four 150, 150′, 150″, 151 and it is possible to have for example even 5 or 6 groups of cell modules.

A reason for including the additional set of cell modules 151 is that the additional set of cell modules 151 allows for the control unit 20, 20′ to control the total voltage between the poles 19, 17 with finer resolution, actually to a resolution corresponding to the number of cells in the cell module divided by a factor of two, three or an even greater integer. In case each of the cell modules inside the additional set of cell modules 151 only consists of one cell, and that the group of cell modules 151 only includes one cell module, the voltage resolution may be ½ or 1/3 or even 1/N of the voltage of a single cell.

With improved voltage resolution, the control unit 20, 20′ can control the voltage between the poles in finer steps and also the current distribution between the circuit arrangements 10, 10′ can be controlled in finer steps, which is an advantage, especially in case of parallel connected circuit configurations. In case the voltage can be controlled to a resolution corresponding to one cell, typically 3.6V, The DC-link voltage can be controlled to a resolution of +/−1.8V. In case of two circuit configurations in parallel, each with an internal resistance of 0.1 ohm, this corresponds to a possibility to control the current through one circuit configuration with a resolution of +/−1.8 V/0.2 ohm=+/−9 A, which means in steps of 18A. With an improved voltage resolution, it is possible to improve this value, which can be important especially for circuit configurations with an even lower internal resistance than 0.1 ohm.

FIG. 6 is an example how a group of cell modules 151 can be designed to achieve a resolution corresponding to half the voltage of one cell module. In this example the number of cell modules 120 in the group of cell modules 151 is one. The number of cells 121 in the cell module 120 is also one. In the electronic module 100, there are now two pair of transistors, one transistor pair 125 and another transistor pair 127. The transistor pair 125, determines if the cell module 120 is included or not in the series connection, as previously mentioned. The transistor pair 127 is parallel connected to a flying capacitor 122, which is charged to approximately half of the voltage of the cell module 120, in this case half of the voltage of the cell 121. The circuit 100 is measuring the voltage across the capacitor 122 and is configured to control this voltage to a value which is approximately half of voltage across the battery cell 121.

By turning on transistor 130 and 141, while transistor 131 and 140 is off, it is possible to produce a voltage V between the group of cell modules 151 output terminals 152 and 153, which is equal to approximately half of the cell voltage of the cell 121. Approximately the same output voltage can be achieved by turning on transistor 140 and 131, while transistor 130 and 141 is off. By switching between these two mentioned states, the circuit 110 can balance the voltage across the capacitor 122. The capacitor 122 can preferably be a so called supercapacitor with very high capacitance value (typically 100° F. to 1000° F. and very low internal resistance, typically 1 mohm or less). In this case, the two transistor pairs can use a low switching frequency, typically in the range of 10 Hz to control the voltage across the capacitor 122, to approximately half the voltage of the cell 121. By using a higher switching frequency than 10 Hz for controlling the capacitor voltage, it is possible to reduce the capacitance value of the capacitor 122. If transistor 130 and 131 is turned on, while the transistors 141 and 140 is off, the output voltage equals or close to the cell voltage of cell 121.

If transistor 140 and 141 is turned on, while the transistors 131 and 130 is off, the output voltage equals to zero or close to zero.

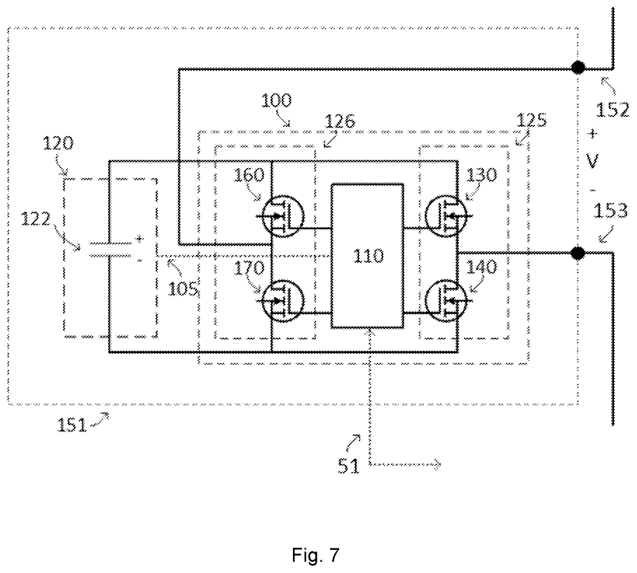

FIG. 7 is an example how a group of cell modules 151 can be designed to achieve a resolution corresponding to plus/minus one third of a cell voltage. In this example the number of cell modules 120 in the group of cell modules 151 is one. The number of cells 121 in the cell module 120 is also one. In this case the cell 122 storing the energy is not a battery cell but instead a supercapacitor with high capacitance, such as 100° F.-10000° F. or similar, the higher the better. In the electronic module 100, there are now two pair of transistors, one transistor pair 125 and another transistor pair 126 connected in a full bridge configuration. The voltage of the capacitor 122 is controlled by the circuit 110, to be approximately one third of the nominal cell voltage of the cell used in the other cell modules in the circuit arrangement. By doing so, it is possible to output a voltage V across the terminal of the group of cell module 151, which is either +1/3 of a cell voltage, 0 or −1/3 of a cell voltage. In case a nominal cell voltage of 3.6V is used, the capacitor 122 shall be charged to a voltage level of approximately 1.2V. If it deviates to much from this voltage, the circuit 110 can control the transistor pairs 125 and 126 such that it 50% of the time is producing an output voltage of +1.2V and 50% of the time the voltage −1.2V. By selecting the capacitor value large enough, this is normally possible to achieve without using any high switching frequency and typically a switching frequency of 10 Hz or less can be used.

Even though embodiments of the various aspects have been described, many different alterations, modifications and the like thereof will become apparent for those skilled in the art. The described embodiments are therefore not intended to limit the scope of the present disclosure.

1. A circuit arrangement (10) for controlling an output voltage of the circuit arrangement (10) towards a voltage target for exchange of electric power with an electric power unit (230, 300), comprising:
battery cells (121) forming a plurality of series-connectable cell modules (120, 120′)
a pair of terminals (17, 19) for connection of the electric power unit (230, 300), wherein the output voltage between the pair of terminals (17,19) is controllable,
wherein each series-connectable cell module (120, 120′) is connected to a respective electronic module (100, 100′) controllable to include said each cell module (120, 120′) for contribution to the output voltage or to bypass said each cell module (120, 120′) for exclusion from contribution to the output voltage,
wherein the circuit arrangement (10) is characterized by that
the series-connectable cell modules (120, 120′) comprise:
a first group of cell modules (150) comprising a first number of cell modules (150), wherein each cell module (120, 120′) of the first group has a first nominal cell module voltage in a range of 30-200 V,
at least one second group of cell modules (150′) comprising a second number of cell modules (150′), wherein each cell module (120, 120′) of said at least one second group has a second nominal cell module voltage that is less than the first nominal cell module voltage, and by that the circuit arrangement (10) comprises:
a control unit (20) configured to:
measure the output voltage of the circuit arrangement (10), and
in order to control the measured output voltage towards the voltage target, control at least one respective electronic module (100, 100′) to adjust a respective contributing number of cell modules (120, 120′) of at least one of the first and second groups, wherein each cell module (120, 120′) of the respective contributing number of cell modules (120, 120′) is contributing, positively or negatively, to the output voltage of the circuit arrangement (10).

2. The circuit arrangement (10) according to claim 1, wherein a first contribution sum of each respective voltage of each cell module (120, 120′) among the respective contributing number of cell modules (120, 120′) of the first group matches the voltage target, wherein any difference between the voltage target and the first contribution sum is matched by a second contribution sum of each respective voltage of each cell module (120, 120′) among the respective contributing number of cell modules (120, 120′) of said at least one second group.

3. The circuit arrangement (10) according to claim 1, wherein the first nominal cell module voltage corresponds to a first number of battery cells in a range of 10-50 cells.

4. The circuit arrangement (10) according to claim 3, wherein the second nominal cell module voltage corresponds to a second number of cells that is less than half the first number of cells.

5. The circuit arrangement (10) according to claim 4, wherein the first number of cells divided by the second number of cells equals an integer that is greater than two.

6. The circuit arrangement (10) according to claim 1, wherein the second number of cell modules (120, 120′) increased by one and then multiplied by the second nominal cell module voltage corresponds to, or is greater than, the first nominal cell module voltage.

7. The circuit arrangement (10) according to claim 1, wherein the second nominal cell module voltage differs from the first nominal cell module voltage by a difference voltage corresponding to 1 to 4 battery cells.

8. The circuit arrangement (10) according to claim 1, wherein the first number of cell modules (120, 120′) and the second number of cell modules (120, 120′) provides a resolution for number of series-connectable battery cells (121), in at least one sub-range of an operating range of the circuit arrangement (10), of 1 to 4 battery cells (121).

9. The circuit arrangement (10) according to claim 1, wherein the cell modules (120, 120′) comprise:
a third group of cell modules (150″) comprising a third number of cell modules (150″), wherein each cell module (120, 120′, 120″) of the third group has a third nominal cell module voltage that is less than the second nominal cell module voltage, wherein a respective contributing number of cell modules (120, 120′, 120″) of the third group is controllable by a respective electronic module (100″) for each cell module (120″) of the third group,
wherein the control unit (20) is configured to:
control at least one respective electronic module (100, 100′, 100″) for one or more of the first, second and third groups to adjust the respective contributing number of cell modules (120, 120′) of at least one of the first, second and third groups, wherein each cell module (120, 120′) of the respective contributing number of cell modules (120, 120′) is contributing, positively or negatively, to the output voltage of the circuit arrangement (10).

10. The circuit arrangement (10) according to claim 1, wherein the control unit (20) is configured to:
perform active cell module balancing among cell modules of the first group by alternatingly switching between a first group configuration and a second group configuration, wherein the first group configuration and the second group configuration include a same number of cell modules that contributes to the voltage target.

11. The circuit arrangement (10) according to claim 1, wherein the control unit (20) is configured to:
perform active group balancing among the first group and the second group by alternatingly switching between a first circuit configuration and a second circuit configuration, wherein
the first circuit configuration and the second circuit configuration include the same number of battery cells that contributes to the voltage target, and/or
a difference in battery cells, that contributes to the voltage target, between the first circuit configuration and the second circuit configuration corresponds to a difference in number of battery cells between cell modules of the first group and cell modules of the second group.

12. A battery arrangement (9) configured to control output voltage towards to a DC link voltage target on a DC link connectable to a power unit (230, 300), comprising:
cell modules (120, 120′) included in:
a first circuit arrangement (10), comprised in the battery arrangement (9), and
at least one second circuit arrangement (10′), comprised in the battery arrangement (9), wherein the first circuit arrangement (10) and said at least one second circuit arrangement (10′) are parallelly connected to a pair of terminals (16, 18) for connection to the power unit (230, 300), and wherein the battery arrangement (9) comprises:
a battery arrangement control unit (70) configured to:
receive information comprising:
a respective measured current for each one of the first and said at least one second circuit arrangement (10, 10′),
a measured voltage on the DC link,
a respective circuit configuration relating to which of the cell modules that contribute to voltage over each of the first and said at least one second circuit arrangement, and receive information comprising:
a target current distribution indicating a respective target current for each of the first and said at least one second circuit arrangement (10, 10′), and
the DC link voltage target, and
wherein the battery arrangement control unit (70) is configured to:
control the output voltage towards the DC link voltage target by assigning changed circuit configurations based on the respective measured current for each one of the first and said at least one second circuit arrangement (10, 10′), the measured voltage on the DC link, and the respective circuit configuration, while reducing, such as minimizing, a loss function defining a measure of the deviation from the target current distribution.

13. The battery arrangement (9) according to claim 12, wherein the battery arrangement control unit (70) is configured to:
apply a model of the battery arrangement (9), wherein the model has model parameters describing dynamic properties of the battery arrangement (9),
estimate the model parameters based on one or more of:
the respective measured current for each one of the first and said at least one second circuit arrangement (10, 10′),
the measured voltage on the DC link, and the like, and
wherein the battery arrangement control unit (70) further is configured to perform the control of the output voltage by use of the model.

14. The battery arrangement (9) according to claim 12,
wherein the battery arrangement control unit (70) is configured to:
apply a further model over the battery arrangement (9), wherein the further model has model parameters describing states of the battery arrangement (9),
estimate the model parameters based on one or more of:
SoC,
SoH,
SoP (State of Power)·
SoT (State of Temperature), and
wherein the battery arrangement control unit (70) further is configured to perform the control of the output voltage by use of the further model.
